(19) United States
(12) Patent Application Publication
(10) Pub. No.: US 2018/0146257 A1
(43) Pub. Date: May 24, 2018

(54) ELECTRONIC APPARATUS AND METHOD OF OPERATING THE SAME

(71) Applicant: SAMSUNG ELECTRONICS CO., LTD., Suwon-si (KR)

(72) Inventors: Seung-gi Seo, Seoul (KR); San-baek Kim, Seongnam-si (KR); Byeong-kyu Park, Seoul (KR); Ho-hyeon Lee, Suwon-si (KR); Seung-ho Choi, Dalseong-gun (KR); Ji-yeon Park, Suwon-si (KR)

(73) Assignee: SAMSUNG ELECTRONICS CO., LTD., Suwon-si (KR)

(21) Appl. No.: 15/819,721

(22) Filed: Nov. 21, 2017

Related U.S. Application Data
(60) Provisional application No. 62/424,662, filed on Nov. 21, 2016.

(30) Foreign Application Priority Data
Mar. 13, 2017 (KR) 10-2017-0031356

(51) Int. Cl. H04N 21/478; G06Q 30/02; G06Q 30/06; H04N 21/81; H04N 21/488; H04N 21/4722; H04N 21/431

(52) U.S. Cl. CPC H04N 21/47815; G06Q 30/0266; G06Q 30/0643; G06Q 30/0623; H04N 21/4312; H04N 21/4882; H04N 21/8126; H04N 21/4722; H04N 21/812

(57) ABSTRACT

Provided are an electronic apparatus and a method of operating the same. The electronic apparatus includes: a communication interface; and at least one processor configured to: control the communication interface to receive, from one or more servers, a product list including one or more products related to broadcast content viewed by a user; control to output the received product list; control the communication interface to receive, from the one or more servers in response to a selection of a product from the output product list, advertisement information of the selected product; and control to output the received advertisement information and an image of a scene in the broadcast content related to the selected product.

### CROSS-REFERENCE TO RELATED APPLICATIONS

This application claims the benefit of U.S. Provisional Application No. 62/424,662, filed on Nov. 21, 2016 in the U.S. Patent and Trademark Office, and claims priority from Korean Patent Application No. 10-2017-0031356, filed on Mar. 13, 2017 in the Korean Intellectual Property Office, the disclosures of which are incorporated herein in their entireties by reference.

### BACKGROUND

### 1. Field

Apparatuses and methods consistent with one or more exemplary embodiments relate to electronic apparatuses and methods of operating the same, and more particularly, to electronic apparatuses for providing information about products and methods of operating the electronic apparatuses.

### 2. Description of the Related Art

A user may view broadcast content on an electronic apparatus. In particular, the electronic apparatus outputs broadcast content corresponding to a selection of the user from among broadcast signals broadcasted by broadcasting companies. Globally, analog broadcast content has been replaced with digital broadcast content.

Digital broadcast content refers to broadcast content including digital video and audio signals. Compared to analog broadcast content, the digital broadcast content has high resistance against external noise, small data loss, and easy error correction and can include high-definition videos. Furthermore, unlike the analog broadcast content, bidirectional services regarding digital broadcast content have become available.

Currently, in addition to a digital broadcast function, a smart device (e.g., a set-top box (STB) or a television (TV)) also has a connecting function to allow connection to various sources to reproduce various types of content or to receive over-the-top (OTT) services. The smart device is intended to replace manual operations based on selections of a user with user-desired services, such as product analysis, without manipulation or input by the user.

### SUMMARY

According to an aspect of an exemplary embodiment, there is provided an electronic apparatus for providing information about products, the electronic apparatus including: a communication interface; and at least one processor configured to: control the communication interface to receive, from one or more servers, a product list including one or more products related to broadcast content viewed by a user; control to output the received product list; control the communication interface to receive, from the one or more servers in response to a selection of a product from the output product list, advertisement information of the selected product; and control to output the received advertisement information and an image of a scene in the broadcast content related to the selected product.

The electronic apparatus may further include a display, wherein the at least one processor may be further configured to control the display to display the received product list, the image of the scene in the broadcast content related to the selected product, and the received advertisement information related to the selected product.

The at least one processor may be further configured to control to output, based on outputting of the broadcast content ending, a notification message for providing information about the one or more products related to the broadcast content, and to control to output the received product list including the one or more products related to the broadcast content, outputting of which is ended, in response to receiving an input for selecting the notification message.

The at least one processor may be further configured to determine first content and second content based on a viewing history of the user, and to control to output a first product list including one or more products related to the first content and a second product list including one or more products related to the second content.

The at least one processor may be further configured to determine the first content and the second content based on at least one of a preference of the user and broadcast contents recently viewed by the user.

The received advertisement information of the selected product may include at least one of a name, a price, a manufacturer, a brief description, and an image of the product.

The at least one processor may be further configured to control to output the received product list by using thumbnail images of scenes in the broadcast content related to the one or more products.

The at least one processor may be further configured to control to transmit a message including purchase service information for purchasing the selected product to an external device in response to receiving an external input for selecting the product from the output product list.

The product list may include a first product and a second product; and the at least one processor may be further configured to control to output advertisement information of the first product and an image of a scene in the broadcast content related to the first product, and to control to output advertisement information of the second product and an image of a scene in the broadcast content related to the second product based on outputting of the advertisement information of the first product ending.

The at least one processor may be further configured to control to output a broadcast content list including one or more broadcast contents based on a viewing history of the user and to control to output a product list including one or more products related to a selected broadcast content in response to receiving an input for selecting the broadcast content from the output broadcast content list.

The at least one processor may be further configured to transmit, to an external device, a notification message for providing information about the one or more products related to the broadcast content.

According to an aspect of another exemplary embodiment, there is provided a method of operating an electronic apparatus, the method including: receiving, from one or more servers, a product list including one or more products related to broadcast content viewed by a user; outputting the received product list; receiving, from the one or more servers, advertisement information of a selected product in response to a selection of the product from the output product list; and outputting the received advertisement information and an image of a scene in the broadcast content related to the selected product.

The method may further include outputting, based on outputting of the broadcast content ending, a notification message for providing information about the one or more products related to the broadcast content, wherein the outputting of the received product list may include outputting the received product list including the one or more products related to the broadcast content, outputting of which is ended, in response to receiving an input for selecting the notification message.

The method may further include determining first content and second content based on a viewing history of the user; and outputting a first product list including one or more products shown in the first content and a second product list including one or more products shown in the second content.

The determining of the first content and the second content may include determining the first content and the second content based on at least one of a preference of the user and information about broadcast contents recently viewed by the user.

The received advertisement information of the selected product may include at least one of a name, a price, a manufacturer, a brief description, and an image of the product.

The outputting of the received product list may include outputting the received product list by using thumbnail images of scenes in the broadcast content related to the one or more products.

The method may further include transmitting a message including purchase service information for purchasing the selected product to an external device in response to receiving an external input for selecting the product from the output product list.

The product list may include a first product and a second product; and the method may further include: outputting advertisement information of the first product and an image of a scene in the broadcast content related to the first product; and outputting advertisement information of the second product and an image of a scene in the broadcast content related to the second product based on outputting of the advertisement information of the first product ending.

According to an aspect of another exemplary embodiment, there is provided a non-transitory computer-readable recording medium having recorded thereon a program for executing the method.

According to an aspect of another exemplary embodiment, there is provided a method of operating an electronic apparatus, the method including: controlling to receive, from one or more external devices, a product list including one or more products related to broadcast content viewed by a user; controlling to output the received product list; and controlling to output, in response to a selection of a product from the output product list, advertisement information of the selected product and an image of a scene in the broadcast content related to the selected product.

The method may further include controlling to output, based on outputting of the broadcast content ending, a notification message for providing information about the one or more products related to the broadcast content, wherein the controlling to output the received product list may include controlling to output the received product list including the one or more products related to the broadcast content, outputting of which is ended, in response to receiving an input for selecting the notification message.

The method may further include determining first content and second content based on a viewing history of the user; and controlling to output a first product list including one or more products shown in the first content and a second product list including one or more products shown in the second content.

The determining of the first content and the second content may include determining the first content and the second content based on at least one of a preference of the user and information about broadcast contents recently viewed by the user.

The advertisement information of the selected product may include at least one of a name, a price, a manufacturer, a brief description, and an image of the product.

The controlling to output the received product list may include controlling to output the received product list by using thumbnail images of scenes in the broadcast content related to the one or more products.

The method may further include controlling to transmit a message including purchase service information for purchasing the selected product to an external device in response to receiving an external input for selecting the product from the output product list.

According to an aspect of another exemplary embodiment, there is provided a non-transitory computer-readable recording medium having recorded thereon a program for executing the method.

### BRIEF DESCRIPTION OF THE DRAWINGS

These and/or other aspects will become apparent and more readily appreciated from the following description of exemplary embodiments, taken in conjunction with the accompanying drawings in which:

FIG. 1 is a schematic view of an electronic apparatus for providing information about products, according to an exemplary embodiment;

FIG. 2 is a block diagram of an electronic apparatus according to an exemplary embodiment;

FIG. 3 is a block diagram of an electronic apparatus according to another exemplary embodiment;

FIGS. 4A to 4D are schematic views showing an example in which the electronic apparatus provides information about products related to broadcast content, according to an exemplary embodiment;

FIGS. 5A and 5B are schematic views showing an example in which the electronic apparatus provides different types of product information based on broadcast contents, according to an exemplary embodiment;

FIGS. 6A to 6D are schematic views showing an example in which the electronic apparatus transmits purchase service information of a product to an external device, according to an exemplary embodiment;

FIG. 7 is a schematic view showing an example in which the electronic apparatus provides information about products by using an application, according to an exemplary embodiment;

FIG. 8 is a schematic view showing an example in which the electronic apparatus provides information about a product related to broadcast content, according to another exemplary embodiment;

FIG. 9 is a schematic view showing an example in which the electronic apparatus transmits information about a product to an external device, according to an exemplary embodiment;

FIGS. 10A to 10D are schematic views showing an example in which the external device provides information about a product related to broadcast content, according to an exemplary embodiment;

FIG. 11 is a schematic view showing an example in which the external device displays information about products based on tags, according to an exemplary embodiment;

FIG. 12 is a schematic view showing an example in which a product is purchased by using the external device, according to an exemplary embodiment;

FIG. 13 is a flowchart of a video display method according to an exemplary embodiment; and

FIG. 14 is a schematic view showing correlations among devices used to implement the video display method, according to an exemplary embodiment.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. In the drawings, parts irrelevant or insignificant to the description of exemplary embodiments are not illustrated and like reference numerals denote like elements.

Although the terms used in the following description are selected, as much as possible, from general terms that are widely used at present while taking into consideration the functions obtained in accordance with exemplary embodiments, these terms may be replaced with other terms based on intentions of those skilled in the art, customs, emergence of new technologies, or the like. Accordingly, it should be noted that the terms used herein should be construed based on practical meanings thereof and the whole content of this specification, rather than being simply construed based on names of the terms.

The terminology used herein is for the purpose of describing particular exemplary embodiments and is not intended to limit the exemplary embodiments. It is understood that expressions such as “at least one of,” when preceding a list of elements, modify the entire list of elements and do not modify the individual elements of the list. Additionally, as used herein, the singular forms “a,” “an,” and “the” are intended to include the plural forms as well, unless the context clearly indicates otherwise. Throughout the specification, the term “communication” includes communication based on the unidirectional communication standards and the bidirectional communication standards. When an element, such as a layer, a region, or a substrate, is referred to as being “connected to” another element, it may be “directly connected” to the other element or may be “electrically connected” to the other element through intervening elements. The terms “comprises,” “comprising,” “includes” and/or “including” specify the presence of stated elements but do not preclude the presence or addition of one or more other elements, unless the context clearly indicates otherwise.

As used in this specification and, more particularly, in the claims, demonstrative pronouns such as “the” are intended to include both singular and plural forms. Steps of a method described herein may be performed in any suitable order unless the context clearly indicates otherwise, and the described order of steps is not intended to limit the exemplary embodiments.

In this specification, a phrase such as “in some exemplary embodiments” or “in an exemplary embodiment” does not necessarily refer to the same exemplary embodiment(s).

Exemplary embodiments may be described in terms of functional block components and various processing steps. Some or all of the functional blocks may be realized by any number of hardware and/or software components configured to perform specific functions. For example, the functional blocks may be realized by one or more microprocessors or circuit components for certain functions. In addition, for example, the functional blocks may be implemented with various programming or scripting languages. The functional blocks may be implemented in algorithms that execute on one or more processors. Furthermore, any number of conventional and related art techniques may be employed for electronic settings, signal processing and/or data processing. The terms “element,” “means,” and “unit” are used broadly and are not limited to mechanical or physical elements.

Furthermore, connecting lines or connectors shown in the drawings are intended to represent examples of functional relationships and/or physical or logical couplings between various elements. It should be noted that many alternative or additional functional relationships, physical connections or logical connections may be present in a practical device.

Exemplary embodiments will now be described in detail with reference to the attached drawings.

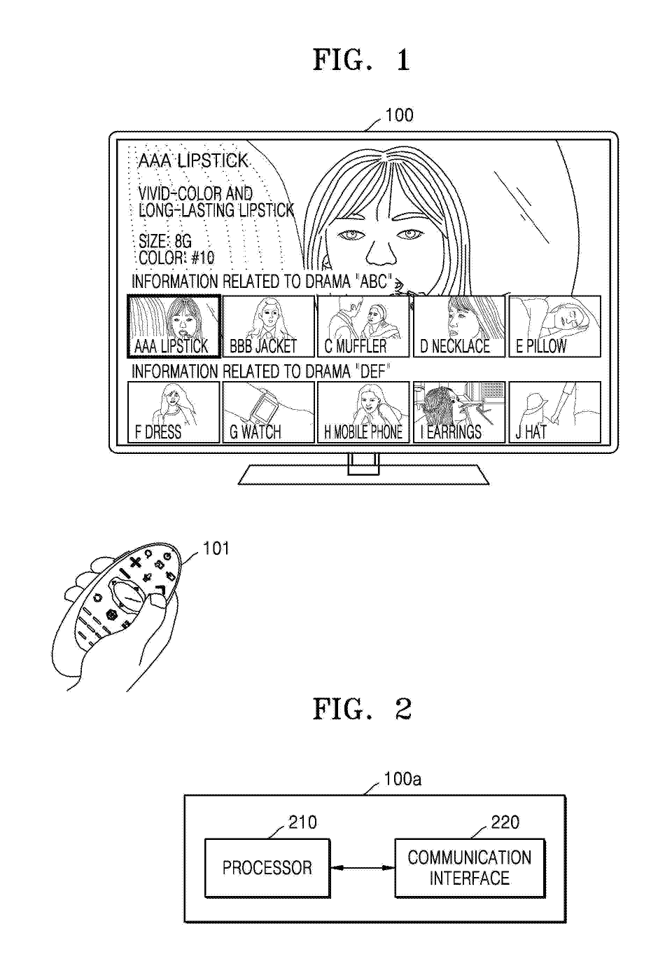

FIG. 1 is a schematic view of an electronic apparatus 100 for providing information about products, according to an exemplary embodiment.

Referring to FIG. 1, the electronic apparatus 100 may be a television (TV), but is not limited thereto and may be any apparatus including a processor and a communication interface. For example, the electronic apparatus 100 may be a mobile phone, a tablet personal computer (PC), a digital camera, a camcorder, a laptop computer, a desktop computer, an e-book device, a digital broadcast device, a personal digital assistant (PDA), a portable multimedia player (PMP), a navigation system, an MP3 player, a wearable device, etc. The electronic apparatus 100 may be a stationary or portable apparatus and may be a digital broadcast receiver capable of receiving digital broadcast contents.

The electronic apparatus 100 may be a flat display device, a curved display device having a fixed curvature, or a flexible display device having an adjustable curvature. The electronic apparatus 100 may have, for example, high definition (HD), full HD, ultra HD, or higher output resolution.

According to an exemplary embodiment, the electronic apparatus 100 may include a set-top box or an Internet protocol (IP) set-top box. The set-top box or the IP set-top box may refer to a device for providing multimedia communication services using an external network. The set-top box or the IP set-top box may be connected to an external video display device and provide information about products related to broadcast content viewed by a user.

The set-top box or the IP set-top box according to an exemplary embodiment may collect a viewing history of the user by receiving the viewing history of the user from the external video display device, or by monitoring and obtaining the viewing history of the user directly. In addition, the set-top box or the IP set-top box may transmit to the external video display device information about one or more products related to the broadcast content viewed by the user. For example, the set-top box or the IP set-top box may transmit the information by using an e-mail or a text message based on the collected viewing history of the user, although it is understood that one or more other exemplary embodiments are not limited thereto.

The electronic apparatus 100 may be controlled by a control device 101, and the control device 101 may be a device for controlling the electronic apparatus 100, e.g., a remote controller or a mobile phone. Alternatively, when a display of the electronic apparatus 100 is a touchscreen or the electronic apparatus 100 otherwise includes an input interface (e.g., buttons, a rotatable dial, etc.), the control device 101 may be replaced with a finger of the user, an input pen, or the like.

The control device 101 may control the electronic apparatus 100 via short-range communication, e.g., infrared communication or Bluetooth communication. The control device 101 may control functions of the electronic apparatus 100 by using at least one of embedded keys (or buttons), a touchpad, a microphone capable of receiving speech of the user, and a sensor capable of detecting motion of the control device 101.

The control device 101 may include a power on/off button for turning on or off the electronic apparatus 100. The control device 101 may switch channels, control the volume, select terrestrial/cable/satellite broadcast services, or change settings of the electronic apparatus 100 in response to a user input. The control device 101 may also be a pointing device. For example, the control device 101 may operate as a pointing device when a specific key input is received.

In the present description of exemplary embodiments, the term “user” refers to a person who uses the control device 101 and controls the functions or operations of the electronic apparatus 100, and may include a viewer, a manager, or a technician.

As broadcast contents provided to users have diversified and users' interests in products related to the broadcast contents have increased, various methods and apparatuses for displaying information about the products related to the broadcast contents have been provided.

The electronic apparatus 100 according to an exemplary embodiment may enable the user to easily obtain information about a desired product, by providing the information about the products related to the broadcast content viewed by the user, based on the viewing history of the user.

FIG. 2 is a block diagram of an electronic apparatus 100a according to an exemplary embodiment.

Referring to FIG. 2, the electronic apparatus 100a may include a processor 210 and a communication interface 220. However, it is understood that the electronic apparatus 100a may further include elements other than the illustrated elements, and is not limited to the above-mentioned elements.

The above-mentioned elements will now be described.

The processor 210 may include one or more memories and one or more processors. For example, the memory may create and erase a program module depending on operation of the processor 210, and the processor 210 may process operations of the program module.

The processor 210 according to an exemplary embodiment may control the communication interface 220 to receive, from a server, a product list including one or more products related to broadcast content viewed by a user.

The products related to the broadcast content may include products used in the broadcast content, products introduced in the broadcast content, and products similar to the products used or introduced in the broadcast content, but are not limited thereto. For example, when the user has viewed a drama or a movie, the products related to the broadcast content may refer to products used by characters in the drama or the movie viewed by the user, or products similar to the products used in the drama or the movie. Otherwise, when the user has viewed an information program for introducing or showcasing restaurants, the products related to the broadcast content may refer to the restaurants introduced or showcased in the information program viewed by the user, or restaurants similar to the introduced restaurants, but are not limited thereto. The products related to the broadcast content may be predetermined by a content provider or an advertisement provider and may be selected based on a preference of the user from among the products predetermined by the content provider or the advertisement provider, but are not limited thereto.

For example, the processor 210 may control the communication interface 220 to receive, from the content provider or an external server for providing advertisement information to the electronic apparatus 100a, the product list including the products related to the broadcast content viewed by the user. The processor 210 according to an exemplary embodiment may output (or control to output) product lists including products related to a plurality of contents viewed by the user.

For example, when the electronic apparatus 100a includes a display, the processor 210 may control the display to display the product lists including the products related to the contents viewed by the user. Otherwise, when the electronic apparatus 100a is a set-top box or an IP set-top box or a standalone device (such as a digital broadcasting device or a media streaming device) that does not include a display, the processor 210 may output (or control to output) the product lists so as to be displayed on an external video display device connected to the electronic apparatus 100a.

The processor 210 may control to output product lists including products related to a plurality of contents viewed by the user, on different regions of an internal or external display. For example, the processor 210 may determine a plurality of broadcast contents based on the viewing history of the user. In this case, a plurality of broadcast contents may be determined based on a preference of the user and/or recently viewed broadcast contents from among the broadcast contents viewed by the user. For example, when first content and second content are determined based on the viewing history of the user, the processor 210 may output a first product list including one or more products related to the first content and a second product list including one or more products related to the second content. In this case, the processor 210 may output the first and second product lists on different regions of a display. As such, the processor 210 may enable the user to easily distinguish products related to different broadcast contents.

The processor 210 according to an exemplary embodiment may output the product list by using thumbnail images of scenes in the broadcast content related to the products. For example, when a heroine of a drama viewed by the user uses a particular cosmetic product, the processor 210 may output or include the particular cosmetic product on the product list by using a thumbnail image of a scene (e.g., still image or video image) in the drama related to the particular cosmetic product.

The processor 210 according to an exemplary embodiment may control the communication interface 220 to receive advertisement information of a selected product from the server in response to a selection by the user of the product from the product list. For example, the processor 210 may control the communication interface 220 to receive the advertisement information of the selected product from the content provider or the external server for providing advertisement information to the electronic apparatus 100a.

The processor 210 according to an exemplary embodiment may output an image of a scene (e.g., still image or video image) in the broadcast content related to the selected product and the received advertisement information. In this case, the image of the scene in the broadcast content related to the selected product may include a video and/or a still frame. The video of the scene in the broadcast content related to the selected product may include a video clip of a scene in the broadcast content including the selected product, and the still frame of the scene in the broadcast content related to the selected product may include a still image of the scene in the broadcast content including the selected product. However, the video and the still frame of the scene are not limited thereto in one or more other exemplary embodiments.

For example, when a character wears particular shoes in a movie viewed by the user, the processor 210 may output a video clip of a scene in the movie related to the particular shoes. As such, the processor 210 may enable the user to easily check the scene where the product selected from the product list is shown in the broadcast content. The advertisement information of the product may include at least one of, for example, a name, a price, a brand name, a brief description, an image of the product, etc., but is not limited thereto. The processor 210 may provide information required when the user purchases the product related to the broadcast content by outputting the advertisement information of the product.

For example, when the electronic apparatus 100a includes a display, the processor 210 may control the display to display the image of the scene in the broadcast content related to the selected product and the received advertisement information. Otherwise, when the electronic apparatus 100a is configured as a set-top box, an IP set-top box, or a standalone device that does not include a display, the processor 210 may output the image of the scene in the broadcast content related to the selected product and the received advertisement information so as to be displayed on an external video display device connected to the electronic apparatus 100a.

When the product list includes a plurality of products and an input for selecting a product from the product list is not received, the processor 210 may sequentially provide information about the products. The information about each product may include both of an image or video of a scene in the broadcast content related to the product and advertisement information of the product, but is not limited thereto. Additionally, the provided information about the products may be output for a predetermined period of time in sequence.

For example, when a product list including four products (e.g., first to fourth products) related to a specific broadcast content is output and an input for selecting a product from the product list is not received, the electronic apparatus 100 may initially provide information about the first product and then sequentially provide information about the second to fourth products. In this case, the processor 210 may provide the information about the first product by outputting an image of a scene in the broadcast content related to the first product and outputting advertisement information of the first product.

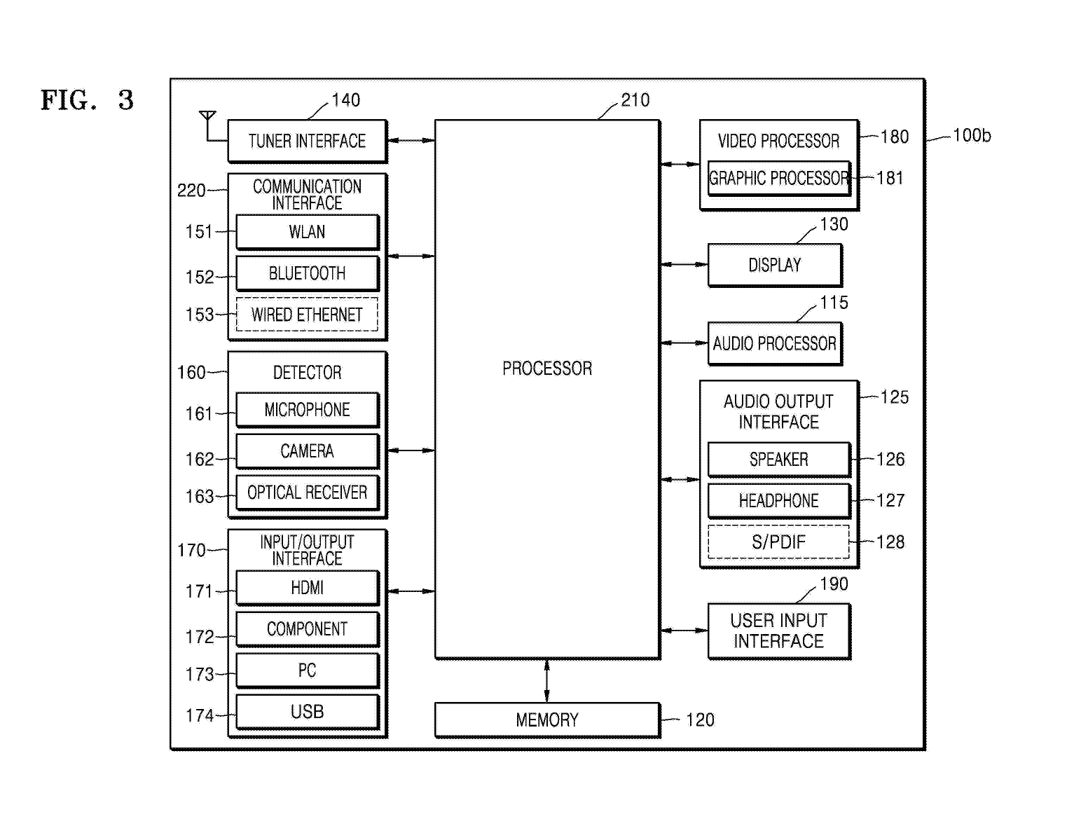

FIG. 3 is a block diagram of an electronic apparatus 100b according to another exemplary embodiment.

As illustrated in FIG. 3, the electronic apparatus 100b may include a processor 210 and a communication interface 220, such as those described above with reference to FIG. 2. Additionally, the electronic apparatus 100 may further include a memory 120, a user input unit 190 (e.g., a user input device, a user inputter, a user input interface, etc.), a tuner interface 140, a display 130, a detector 160, an input/output interface 170, a video processor 180, an audio processor 115, and an audio output interface 125.

The descriptions of the processor 210 and the communication interface 220, which are provided above with reference to FIG. 2, will not be repeated with reference to FIG. 3.

The user input interface 190 refers to a means used when a user inputs data for controlling the electronic apparatus 100b. For example, the user input unit 190 may include a keypad, dome switches, a touchpad, a jog wheel, or a jog switch, but is not limited thereto.

The user input interface 190 may be an element of the above-described control device 101, or an element of the electronic apparatus 100b.

The user input interface 190 according to an exemplary embodiment may receive an input for selecting a product from a product list. When the user input interface 190 is configured as a keypad or a dome switches, the input for selecting the product from the product list displayed on the display 130 may be an input for clicking or pressing a key corresponding to a specific direction. Otherwise, when the user input interface 190 is configured as a touchpad, the input for selecting the product from the product list may be an input for touching a key corresponding to a specific direction. However, the input for selecting the product from the product list is not limited thereto.

The user input interface 190 according to an exemplary embodiment may receive an input for selecting broadcast content for which the user desires to check information about products, from among a plurality of broadcast contents viewed by the user.

Under the control of the processor 210, the display 130 according to an exemplary embodiment may display the product list including one or more products related to the broadcast content viewed by the user. In addition, under the control of the processor 210, the display 130 may display an image or a video of a scene in the broadcast content related to a selected product and advertisement information of the selected product in response to a selection of the product from the product list.

When the display 130 and a touchpad are provided in a layer structure to configure a touchscreen, the display 130 may be used as an input device as well as an output device. The display 130 may include at least one of a liquid crystal display, a thin film transistor-liquid crystal display, an organic light-emitting diode, a flexible display, a three-dimensional (3D) display, an electrophoretic display, etc. Depending on the configuration of the electronic apparatus 100, the electronic apparatus 100 may include two or more displays 130. In this case, the two or more displays 130 may be provided to face each other by using hinges, although it is understood that one or more other exemplary embodiments are not limited thereto.

The display 130 may display a video included in a broadcast signal received through the tuner interface 140 on a screen thereof under the control of the processor 210. In addition, the display 130 may display a content (e.g., a video) input through the communication interface 220 or the input/output interface 170. The display 130 may output an image stored in the memory 120, under the control of the processor 210.

The audio processor 115 process audio data. The audio processor 115 may perform various processing operations, e.g., decoding, amplification, noise filtering, etc., on audio data.

The audio output interface 125 may output an audio included in the broadcast signal received through the tuner interface 140, an audio input through the communication interface 220 or the input/output interface 170, or an audio stored in the memory 120, under the control of the processor 210. The audio output interface 125 may include at least one of a speaker 126, a headphone 127, and a Sony/Philips Digital Interface (S/PDIF: output terminal) 128.

The tuner interface 140 may tune and select the frequency of a channel desired to be received by the electronic apparatus 100b, from among a large number of radio wave components by amplifying, mixing, and resonating a broadcast signal received in a wired or wireless manner. The broadcast signal includes an audio, a video, and additional information (e.g., an electronic program guide (EPG)).

The broadcast signal received through the tuner interface 140 may be divided into the audio, the video, and/or the additional information by performing decoding (e.g., audio decoding, video decoding, or additional information decoding). The divided audio, the video, and/or the additional information may be stored in the memory 120 under the control of the processor 210. The tuner interface 140 of the electronic apparatus 100b may be provided in a singular or plural number. The tuner interface 140 may be integrated with the electronic apparatus 100b (e.g., all-in-one type), or may be configured as another device having a tuner interface electrically connected to the electronic apparatus 100b, or a tuner interface connected to the input/output interface 170.

The communication interface 220 may connect the electronic apparatus 100b to an external device (e.g., an audio device or a video display device) under the control of the processor 210. The processor 210 may transmit/receive a content to/from the external device connected through the communication interface 220, download an application from the external device, or perform web browsing.

The communication interface 220 may transmit information about the products related to the broadcast content viewed by the user, to an external device. In addition, the communication interface 220 may transmit a message including purchase service information required to purchase the products related to the broadcast content viewed by the user, to the external device.

The communication interface 220 may include one of a wireless local area network (WLAN) module 151, a Bluetooth module 152, and a wired Ethernet module 153 to correspond to the performance and structure of the electronic apparatus 100b. Alternatively, the communication interface 220 may include a combination of the WLAN module 151, the Bluetooth module 152, and the wired Ethernet module 153. The communication interface 220 may receive a control signal of the control device 101 under the control of the processor 210. The control signal may be configured in a Bluetooth type, a radio frequency (RF) signal type, or a WiFi type. The communication interface 220 may further include a short-range communication module other than the Bluetooth module 152, e.g., a near field communication (NFC) module or a Bluetooth low energy (BLE) module.

The detector 160 may detect a speech, an image, or an interaction of the user, and include at least one of a microphone 161, a camera 162, and an optical receiver 163.

The microphone 161 receives a speech uttered by the user. The microphone 161 may convert the received speech into an electrical signal and output the electrical signal to the processor 210.

The camera 162 may receive an image (e.g., sequential frames) corresponding to a motion (including a gesture) of the user within a camera recognition range.

The optical receiver 163 receives an optical signal (including a control signal) from an external control device. The optical receiver 163 may receive an optical signal corresponding to a user input (e.g., a touch, a press, a touch gesture, a speech, or a motion) from the control device. A control signal may be extracted from the received optical signal under the control of the processor 210.

According to an exemplary embodiment, the optical receiver 163 may receive, from the control device 101, an optical signal corresponding to an input for selecting a product from the product list. In addition, the optical receiver 163 may receive an optical signal corresponding to an input for requesting to transmit the information about the products related to the broadcast content, to the external device.

The input/output interface 170 receives a video, an audio (e.g., a speech or a music), and additional information (e.g., an EPG) from outside the electronic apparatus 100b under the control of the processor 210. The input/output interface 170 may include one of a high-definition multimedia interface (HDMI) port 171, a component jack 172, a personal computer (PC) port 173, and a universal serial bus (USB) port 174. Alternatively, the input/output interface 170 may include a combination of the HDMI port 171, the component jack 172, the PC port 173, and the USB port 174.

The memory 120 according to an exemplary embodiment may store programs for processing and control operations of the processor 210, and store data input to or output from the electronic apparatus 100b.

The memory 120 may include at least one type of storage medium among flash memory, a hard disk, a multimedia card micro, card-type memory (e.g., secure digital (SD) or extreme digital (XD) memory), random access memory (RAM), static random access memory (SRAM), read-only memory (ROM), electrically erasable programmable ROM (EEPROM), programmable ROM (PROM), magnetic memory, a magnetic disc, and an optical disc.

The memory 120 according to an exemplary embodiment may store one or more instructions for receiving, from a server, the product list including one or more products related to the broadcast content viewed by the user, outputting the received product list, receiving advertisement information of a selected product from the server in response to a selection of the product from the output product list, and outputting an image of a scene in the broadcast content related to the selected product and the received advertisement information.

The processor 210 controls overall operations of the electronic apparatus 100b and the flow of signals among the elements of the electronic apparatus 100b, and processes data. When a user input is received or a stored preset condition is satisfied, the processor 210 may execute an operating system (OS) and various applications stored in the memory 120.

The processor 210 according to an exemplary embodiment may execute the instructions stored in the memory 120 to control the communication interface 220 to receive, from the server, the product list including one or more products related to the broadcast content viewed by the user, output the received product list, control the communication interface 220 to receive the advertisement information of the selected product from the server in response to a selection of the product from the output product list, and output the image of the scene in the broadcast content related to the selected product and the received advertisement information.

The block diagrams of the electronic apparatuses 100a and 100b illustrated in FIGS. 2 and 3 are merely examples. Some elements may be integrated, added, or omitted depending on the actual specifications of the electronic apparatus 100a or 100b. For example, when necessary or desired, two or more elements may be integrated into an element, or an element may be divided into two or more elements. In addition, the functions of blocks are provided merely to describe exemplary embodiments, and operations or devices thereof do not limit the scope of the present disclosure.

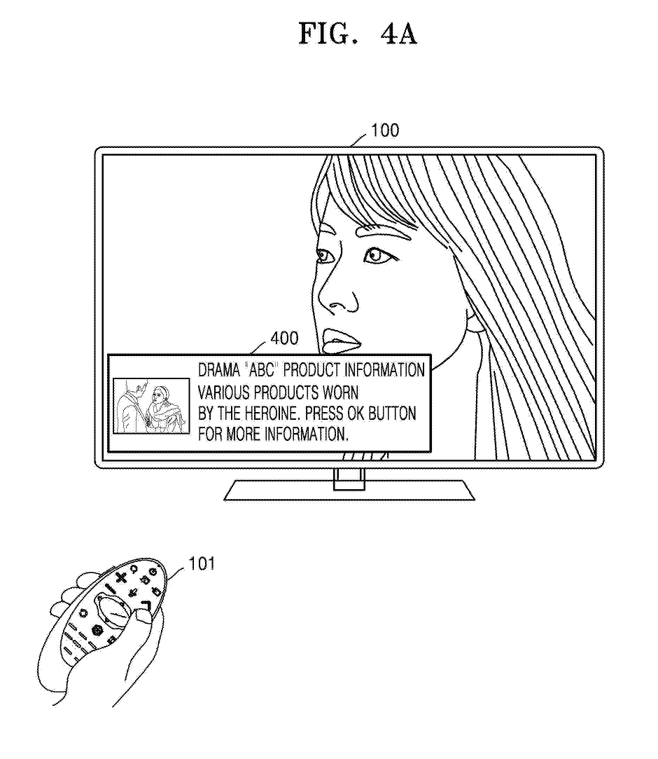

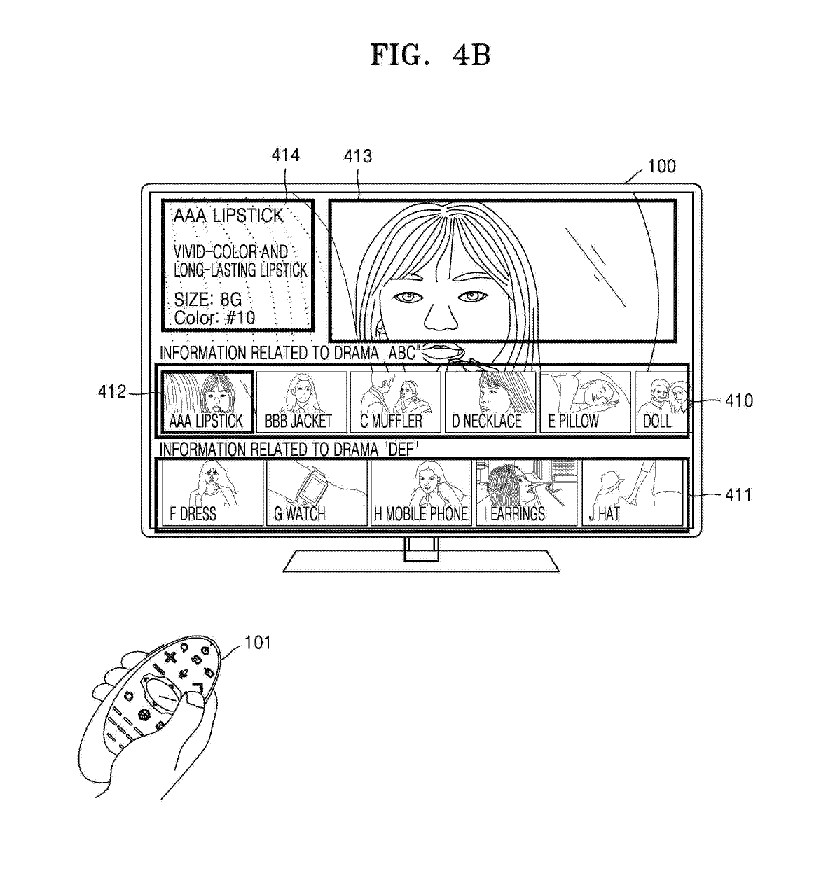

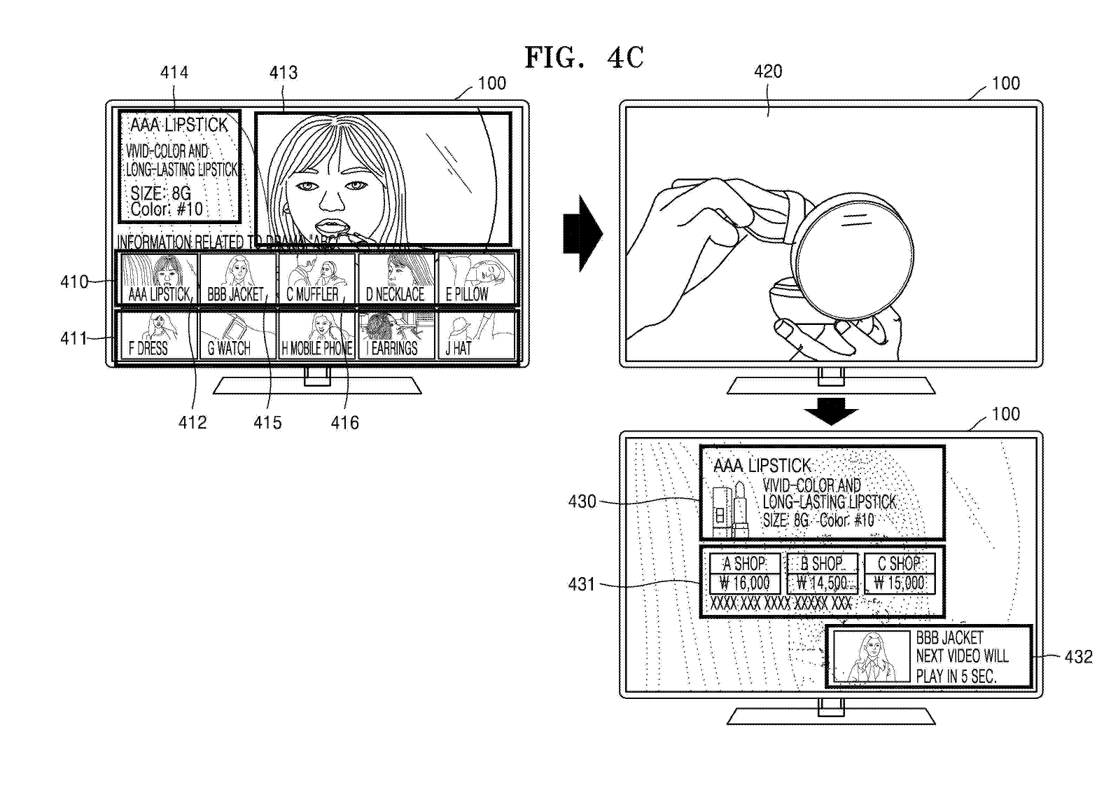

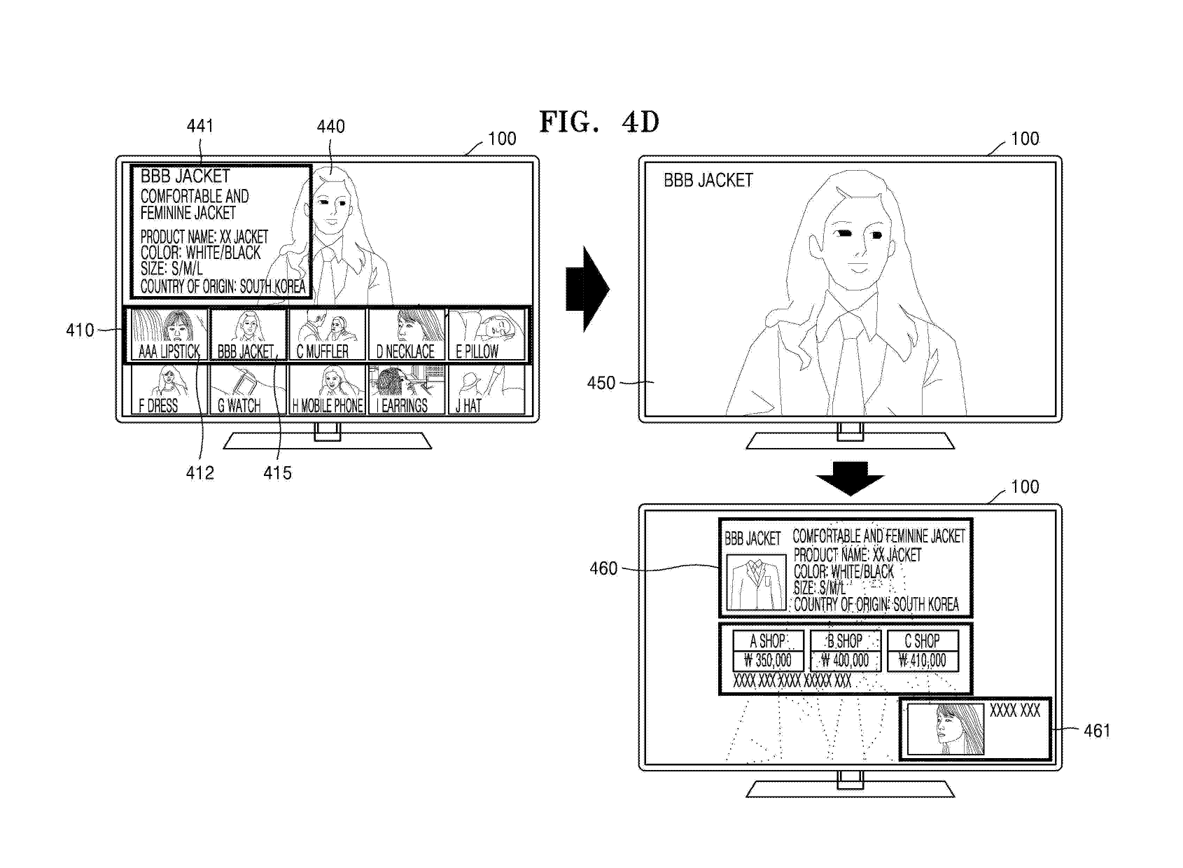

FIGS. 4A to 4C are schematic views showing an example in which the electronic apparatus 100 provides information about products related to broadcast content, according to an exemplary embodiment.

When broadcasting or outputting of broadcast content viewed by a user is terminated (i.e., based on the broadcasting or outputting being terminated), the electronic apparatus 100 according to an exemplary embodiment may output a notification message for providing information about one or more products related to the broadcast content. The information about each product may include an image of a scene in the broadcast content related to the product and advertisement information of the product, but is not limited thereto. For example, referring to FIG. 4A, when broadcasting of a drama “ABC” viewed by the user is terminated, the electronic apparatus 100 may output a notification message 400 for providing information about products related to the drama “ABC.”

As the notification message 400 is output, the electronic apparatus 100 according to an exemplary embodiment may receive an input for requesting the information about the products related to the broadcast content. For example, in response to output of the notification message 400 showing that “Various products worn by the heroine. Press OK button for more information.”, the electronic apparatus 100 may receive an input for selecting the OK button, from the control device 101, but is not limited thereto.

When the input for requesting the information about the products related to the broadcast content is received, the electronic apparatus 100 may output a product list including one or more products related to the broadcast content. In this case, the electronic apparatus 100 may output the product list by using a thumbnail image of a scene in the broadcast content related to each product, but is not limited thereto. For example, referring to FIG. 4B, the electronic apparatus 100 may output a product list 410 including one or more products related to the drama “ABC.” The products related to the drama “ABC” may include products shown in the drama “ABC,” e.g., clothes, shoes, bags, and accessories worn by and cosmetics used by characters of the drama “ABC,” or products similar to the products shown in the drama “ABC,” but are not limited thereto.

Alternatively, the electronic apparatus 100 may output product lists including products related to a plurality of broadcast contents, based on a viewing history of the user. In this case, the electronic apparatus 100 may distinguishably display the product lists related to the broadcast contents. For example, the electronic apparatus 100 may output a first product list including one or more products related to first content and a second product list including one or more products related to second content, on different regions of a display. In this case, the first content may be broadcast content most recently viewed by the user, and the second content may be broadcast content preferred by the user, a content broadcasted in a same or a similar series with the first content, another broadcast content recently viewed by the user, another broadcast content viewed by other viewers determined to have a same or overlapping viewing history, etc. However, the first and second contents are not limited thereto. For example, referring to FIG. 4B, the electronic apparatus 100 may distinguishably display the product list 410 including the products related to the drama “ABC” viewed by the user, and a product list 411 including products related to another drama “DEF” viewed by the user. As such, the electronic apparatus 100 may enable the user to easily find a desired product, based on the viewing history of the user.

The electronic apparatus 100 according to an exemplary embodiment may receive an input for selecting a product from the product list, and distinguishably output the selected product on the product list. For example, referring to FIG. 4B, the electronic apparatus 100 may receive an input for selecting an “AAA lipstick” 412 from the first product list 410 by using the control device 101, and distinguishably output the “AAA lipstick” 412 on the first product list 410. The “AAA lipstick” 412 may be highlighted or shaded to be distinguishably displayed, but is not limited thereto. In addition, according to an exemplary embodiment, when an input for selecting a product from the product list is not received, the electronic apparatus 100 may automatically select an initial product on the first product list 410, and/or sequentially select each of the products in the product list 410 or lists 410 and 411.

The electronic apparatus 100 according to an exemplary embodiment may output an image of a scene in the broadcast content related to the selected product. In this case, the output image may be a still image or a short video having a length of several to several ten seconds, but is not limited thereto. For example, referring to FIG. 4B, the electronic apparatus 100 may output a video clip 413 of a scene in the drama “ABC” including the “AAA lipstick.” Here, the electronic apparatus 100 may output the video clip 413 of a scene in the drama “ABC” where a heroine uses the “AAA lipstick”, but is not limited thereto.

The electronic apparatus 100 according to an exemplary embodiment may output advertisement information of the selected product together with the image of the scene in the broadcast content related to the selected product. The advertisement information of the product may include at least one of a name, a price, a brand name, a brief description, an image, etc., of the product. For example, referring to FIG. 4B, the electronic apparatus 100 may output a name, a brief description, a size, and a color 414 of the “AAA lipstick” selected from the first product list 410.

When the image of the scene in the broadcast content related to the selected product is output, if an external input is not received for a preset time, the electronic apparatus 100 according to an exemplary embodiment may display the image on a whole screen. For example, as illustrated in FIG. 4C, when the video clip 413 of the scene in the drama “ABC” related to the “AAA lipstick” is output, if an external input is not received for a preset time (e.g., 2 seconds), the electronic apparatus 100 may display the video clip 413 of the scene including the “AAA lipstick”, on a whole screen 420. For example, the external input may include an input for selecting a menu for purchasing the “AAA lipstick,” an input for selecting another product 415 or 416 included in the product list 410, or an input for moving to the other product list 411, but is not limited thereto.

When output of the image including the selected product is terminated, the electronic apparatus 100 according to an exemplary embodiment may output the advertisement information of the selected product. Furthermore, according to an exemplary embodiment, the electronic apparatus 100 may display link information for accessing an online site where the selected product is purchasable. For example, referring to FIG. 4C, the electronic apparatus 100 may output advertisement information 430 including a manufacturer, a size, a price, a brief description, and an image of the “AAA lipstick.” In addition, the electronic apparatus 100 may output link information 431 for accessing online stores (e.g., an “A SHOP,” a “B SHOP,” and a “C SHOP”) where the “AAA lipstick” is purchasable. According to another exemplary embodiment, the electronic apparatus may output map information or a link to map information for one or more stores where the “AAA lipstick” is purchasable.

When output of the image of the scene including the selected product is terminated, the electronic apparatus 100 according to an exemplary embodiment may output a notification message for introducing a next product, information of which is to be provided. For example, the next product may be a product next to the currently selected product on the product list 410. In this case, the notification message may include at least one of a thumbnail image of a scene in the broadcast content including the next product, a product name, and a time remaining until a video including the next product is output, but is not limited thereto. For example, referring to FIG. 4C, the electronic apparatus 100 may output a notification message 432 for introducing a “BBB jacket” 415 next to the “AAA lipstick” 412 on the product list 410. In this case, the notification message 432 may include a thumbnail image of a scene in the drama “ABC” including the “BBB jacket,” a product name, and a time (e.g., 5 seconds) remaining until a video clip of the scene in the drama “ABC” including the “BBB jacket” is output.

When an input for selecting a product from the product list is not received for a certain time (e.g., predetermined time period), the electronic apparatus 100 according to an exemplary embodiment may sequentially provide information about the products included in the product list. For example, when a product list including four products (e.g., first to fourth products) related to the broadcast content is output and an input for selecting a product from the product list is not received, the electronic apparatus 100 may initially provide information about the first product and then sequentially provide information about the second to fourth products. In this case, the electronic apparatus 100 may provide the information about the first product by outputting an image of a scene in the broadcast content related to the first product and advertisement information of the first product.

For example, referring to FIG. 4D, when a certain input is not received from outside, the electronic apparatus 100 may provide information about the “BBB jacket” after display of information about the “AAA lipstick” is terminated. In this case, the “BBB jacket” may be a product next to the “AAA lipstick” on the product list 410. For example, the electronic apparatus 100 may output a video 440 of a scene in the drama “ABC” including the “BBB jacket,” and output advertisement information 441 of the “BBB jacket.” Referring to FIG. 4D, the electronic apparatus 100 may output the advertisement information 441 including a name, a brief description, a color, a size, and a country of origin of the “BBB jacket.” When an external input is not received within a preset time (e.g., 2 seconds), the electronic apparatus 100 may display the video 440 of the scene including the “BBB jacket” on a whole screen 450. In addition, when display of the video 440 is terminated, the electronic apparatus 100 may output advertisement information 460 of the “BBB jacket” and a notification message 461 for introducing a next product, information of which is to be provided.

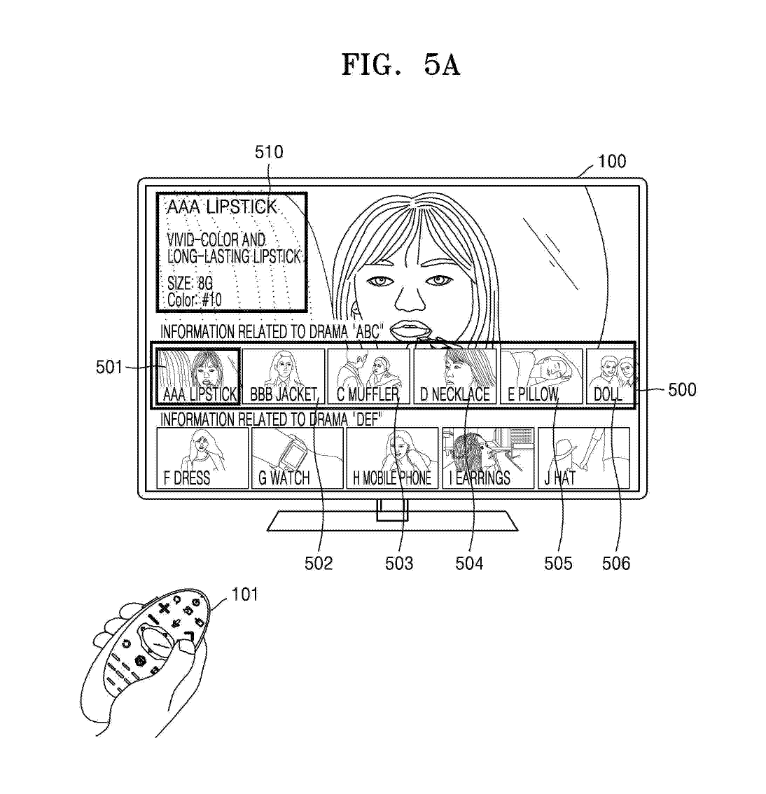

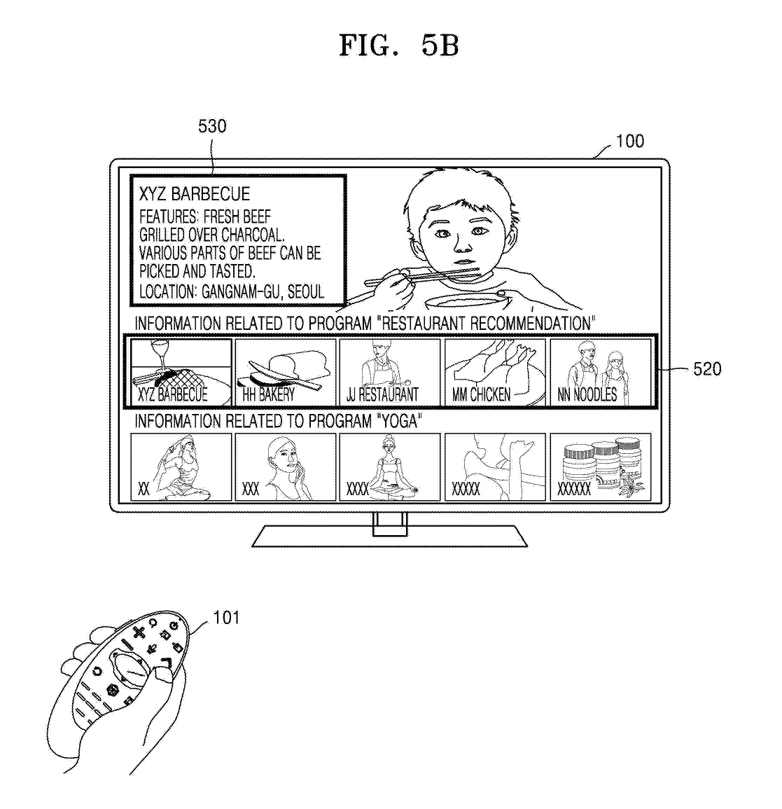

FIGS. 5A and 5B are schematic views showing an example in which the electronic apparatus 100 provides different types of product information based on broadcast contents, according to an exemplary embodiment.

According to an exemplary embodiment, the type of products included in a product list may differ depending on the type of broadcast content viewed by a user.

For example, when the user has viewed a drama or a movie, products related to the broadcast content may include products shown in the drama or the movie, and products similar to the products shown in the drama or the movie. The products shown in the drama or the movie may include clothes, cosmetics, accessories, and cars used by characters in the drama or the movie, and food eaten by the characters, but are not limited thereto. For example, as illustrated in FIG. 5A, when the user has viewed a drama “ABC,” the electronic apparatus 100 may output a product list 500 including a cosmetic product 501, clothes 502, accessories 503 and 504, a bedding item 505, and a doll 506 used by a heroine in the drama “ABC.” In addition, when a product (e.g., an “AAA lipstick”) is selected from the product list 500, the electronic apparatus 100 may output advertisement information 510 including a name, a price, a size, a brief description, etc., of the selected product 501.

Otherwise, when the user has viewed a program for providing certain information, products related to the broadcast content may include products, places, stores, etc., introduced or showcased in the program, but are not limited thereto. For example, as illustrated in FIG. 5B, when the broadcast content viewed by the user is a program for introducing or recommending restaurants, the electronic apparatus 100 may output a product list 520 including the restaurants introduced in the program. Furthermore, when a restaurant (e.g., “XYZ Barbecue”) is selected from the product list 520, the electronic apparatus 100 may output advertisement information 530 including the menu of the restaurant, reasons for recommending the selected restaurant, the location of the restaurant, etc.

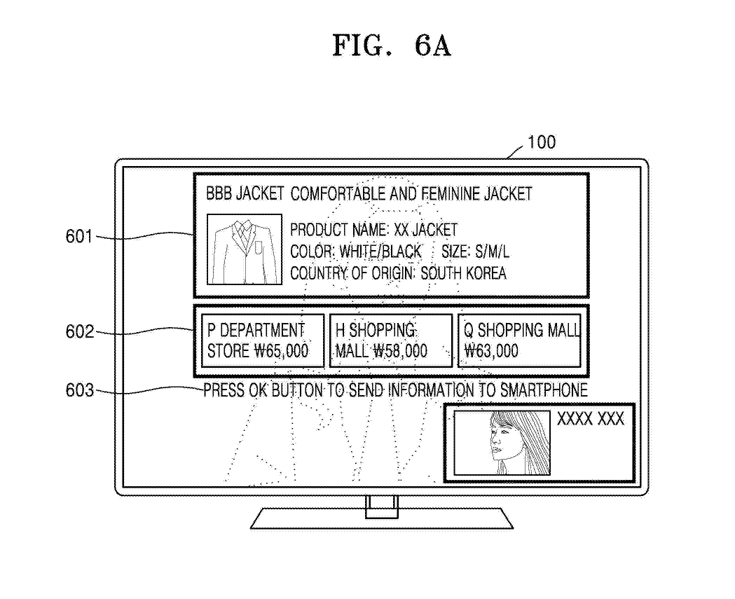

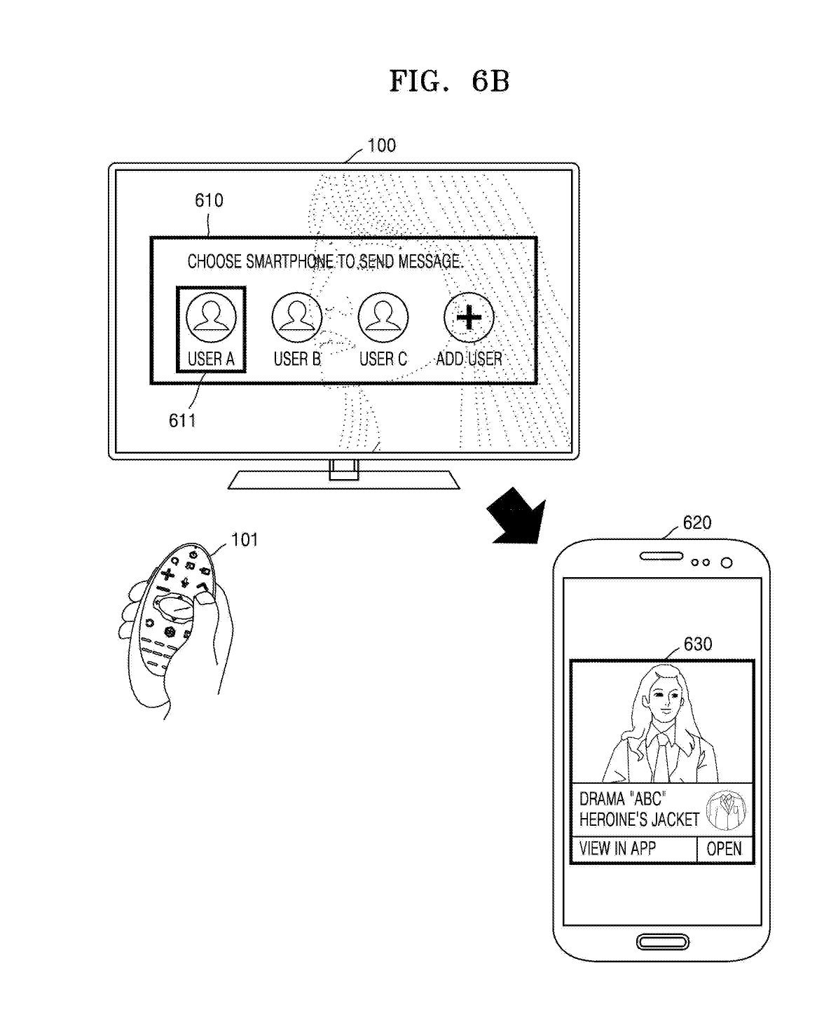

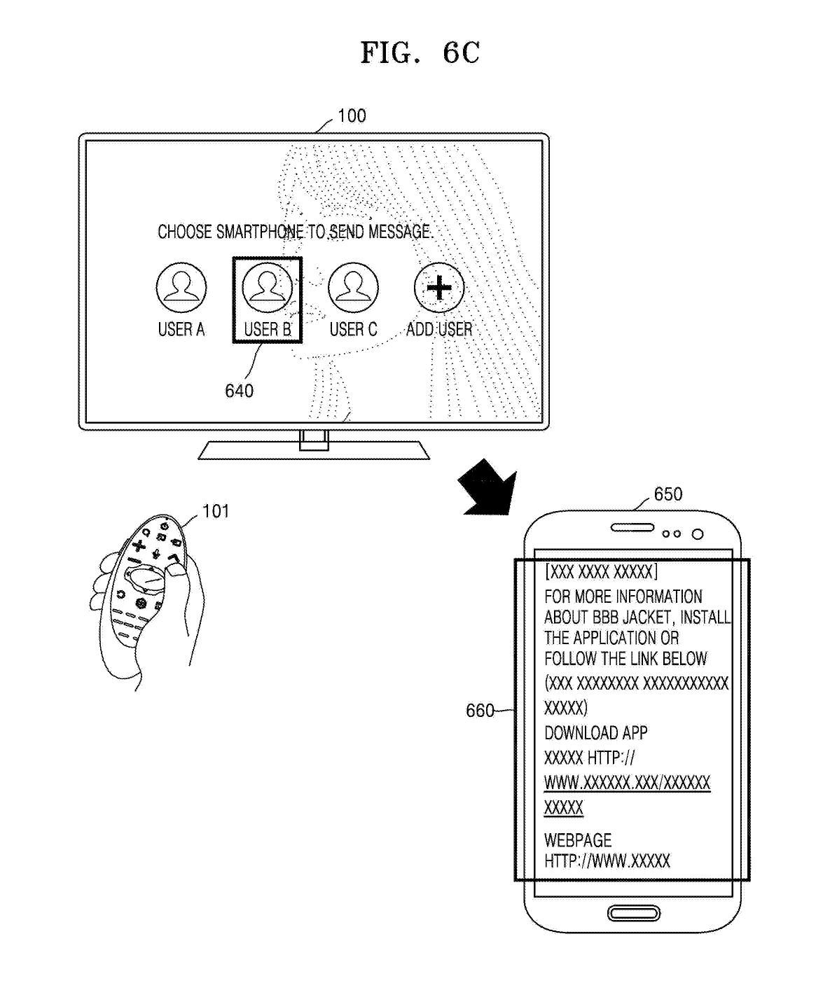

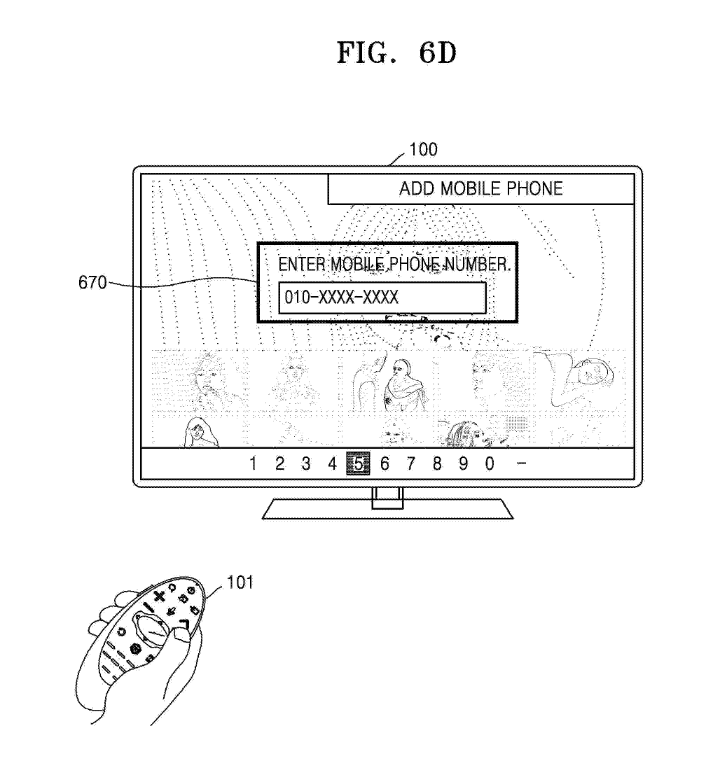

FIGS. 6A to 6D are schematic views showing an example in which the electronic apparatus 100 transmits purchase service information of a product to an external device, according to an exemplary embodiment.

As described above, the electronic apparatus 100 according to an exemplary embodiment may output a product list including one or more products related to broadcast content viewed by a user, and output an image of a scene in the broadcast content related to a selected product and advertisement information of the selected product in response to an external input for selecting the product from the product list. In addition, the electronic apparatus 100 may transmit the advertisement information of the selected product and purchase service information for purchasing the selected product, to an external device. In this case, the external device may include a smartphone, a tablet PC, a mobile phone, a PDA, a laptop computer, a media player, or another mobile device, but is not limited thereto.

For example, referring to FIG. 6A, the electronic apparatus 100 may output advertisement information 601 of a “BBB jacket” and link information 602 for accessing an online shopping mall or store where the “BBB jacket” is purchasable. According to an exemplary embodiment, the link information 602 may include price information of the “BBB jacket” at the online shopping mall(s). In addition, the electronic apparatus 100 may transmit purchase service information for purchasing the “BBB jacket” to the external device in such a manner that the user may conveniently purchase the “BBB jacket.” For example, the purchase service information may include an image, a name, a price, and a brief description of the “BBB jacket,” and link information for accessing an application or a web page where advertisement information 601 of the “BBB jacket” is obtainable, but is not limited thereto. In this case, the electronic apparatus 100 may output a notification message 603 in such a manner that the user may determine whether to transmit the purchase service information to the external device.

When an external input for requesting to transmit the purchase service information to the external device is received, the electronic apparatus 100 may transmit the purchase service information of the selected product to the external device. The external device to which the purchase service information is transmitted may be a device pre-registered in the electronic apparatus 100. When a plurality of external devices are registered in the electronic apparatus 100, the electronic apparatus 100 may receive an external input for selecting one of the registered external devices, and transmit the purchase service information to the selected external device.

For example, referring to FIG. 6B, the electronic apparatus 100 may display a list 610 of three external devices pre-registered in the electronic apparatus 100, and receive an input 611 for selecting an external device (e.g., a mobile device 620 of a user A) from the list 610. In this case, the input 611 for selecting an external device may be an input received from the control device 101, but is not limited thereto. Since the input 611 for selecting the mobile device 620 of the user A is received, the electronic apparatus 100 may transmit the purchase service information to the mobile device 620 of the user A.

According to an exemplary embodiment, the purchase service information may be transmitted in the form of a push message, a text message, an email message, etc., but is not limited thereto. For example, when an application operating in conjunction with the electronic apparatus 100 is installed in the external device, the electronic apparatus 100 may transmit the purchase service information in the form of a push message. As such, the electronic apparatus 100 may enable the user to conveniently obtain the purchase service information and purchase the selected product by using the application installed in the external device.

For example, as illustrated in FIG. 6B, when the application is installed in the mobile device 620 of the user A, the electronic apparatus 100 may transmit the purchase service information of the selected product in the form of a push message 630. The mobile device 620 of the user A may execute a certain application by using the received push message 630, and obtain the purchase service information of the selected product and purchase the selected product by using the application. Alternatively, as illustrated in FIG. 6C, when an input 640 for selecting a mobile device 650 of a user B is received and the application is not installed in the mobile device 650 of the user B, the electronic apparatus 100 may transmit the purchase service information in the form of a text message 660. For example, the text message 660 may include link information for downloading the application and link information of a web page from which the purchase service information is obtainable, but is not limited thereto.

The electronic apparatus 100 according to an exemplary embodiment may register a new external device and transmit the purchase service information to the registered external device. For example, referring to FIG. 6D, to register a new external device, the electronic apparatus 100 may receive an external input 670 for inputting a phone number (e.g., “010-xxxx-xxxx”) of an external device to be registered. The electronic apparatus 100 may register an external device corresponding to the received phone number and transmit the purchase service information to the registered external device.

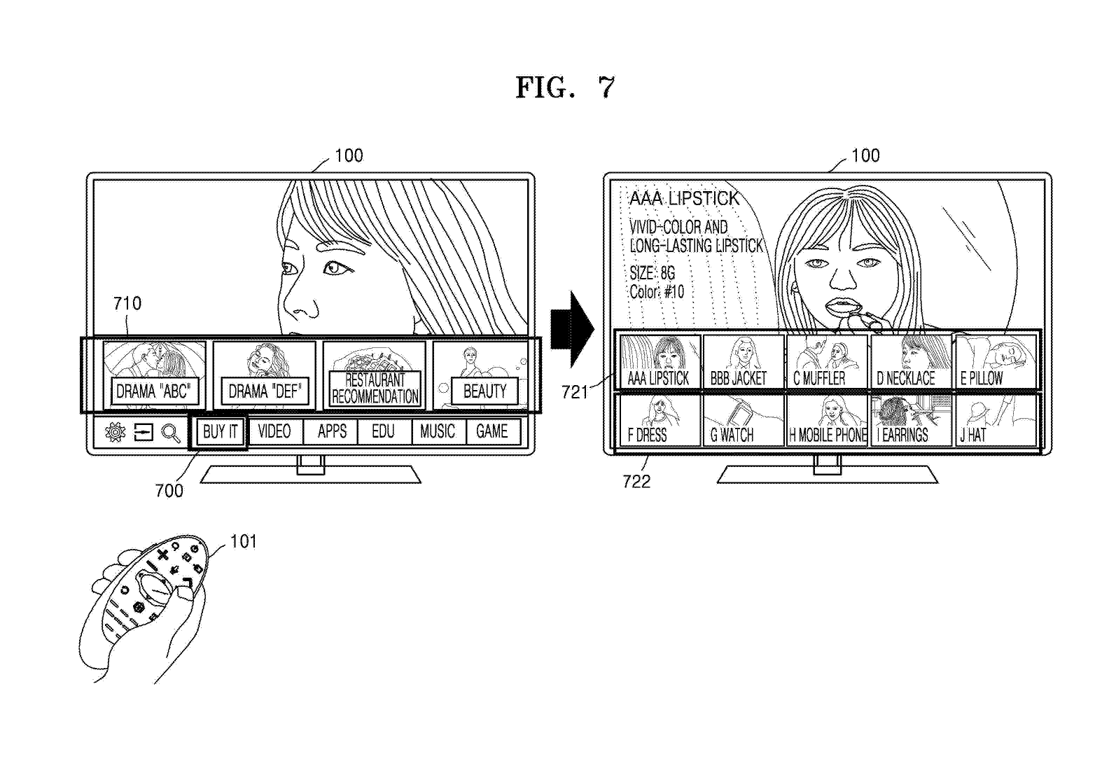

FIG. 7 is a schematic view showing an example in which the electronic apparatus 100 provides information about products by using an application, according to an exemplary embodiment.

The electronic apparatus 100 according to an exemplary embodiment may provide information about products related to broadcast content, by using an application installed in the electronic apparatus 100.

For example, the application installed in the electronic apparatus 100 may be an application used to provide information about one or more products related to broadcast content viewed by a user, based on a viewing history of the user.

For example, as illustrated in FIG. 7, when an external input for moving a focus is received from the control device 101 and thus the focus is located at a certain application 700 among a plurality of menus, the electronic apparatus 100 may output a list 710 including one or more broadcast contents viewed by the user. For example, the electronic apparatus 100 may output the list 710 including a drama “ABC,” a drama “DEF,” a program “Restaurant Recommendation,” and a program “Beauty” viewed by the user. In this case, the electronic apparatus 100 may display the broadcast contents in an order from broadcast content most recently viewed by the user or broadcast content preferred by the user, but is not limited thereto. According to an exemplary embodiment, when the list 710 including the broadcast contents viewed by the user is displayed, the electronic apparatus 100 may also output the number of products related to each broadcast content.

When an input for selecting the application 700 is received and the application 700 is executed, the electronic apparatus 100 may output a product list including one or more products related to each broadcast content, based on the order of the broadcast contents displayed on the list 710. For example, referring to FIG. 7, when the broadcast contents are displayed on the list 710 in the order of the drama “ABC,” the drama “DEF,” the program “Restaurant Recommendation,” and the program “Beauty,” the electronic apparatus 100 may output a product list 722 including products related to the drama “DEF,” after a product list 721 including products related to the drama “ABC.”

As described above, the electronic apparatus 100 according to an exemplary embodiment may enable the user to easily obtain information about products related to broadcast content, by using an application.

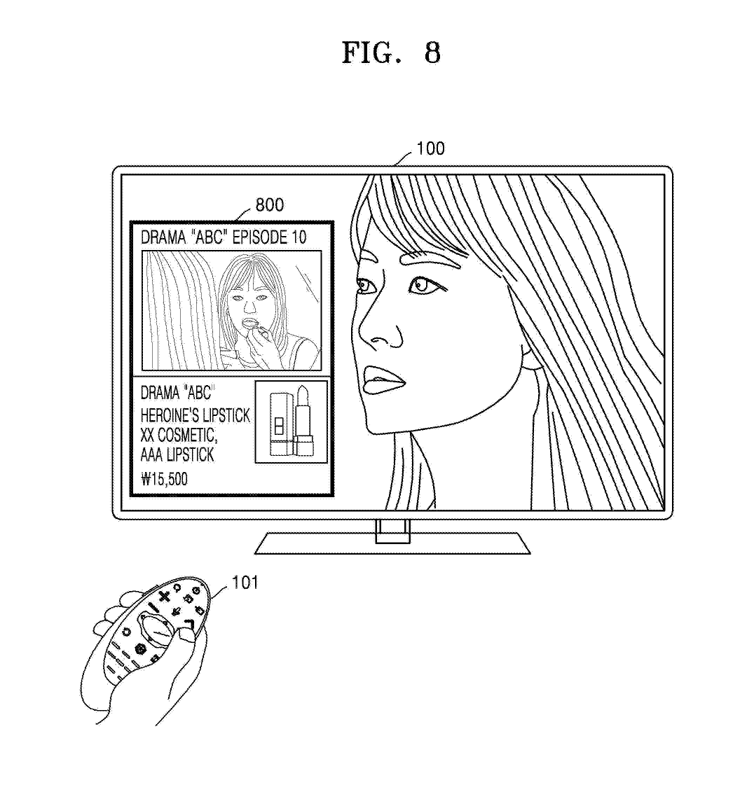

FIG. 8 is a schematic view showing an example in which the electronic apparatus 100 provides information about a product related to broadcast content, according to another exemplary embodiment.

The electronic apparatus 100 according to an exemplary embodiment may output information about a product related to broadcast content, on a partial region of a screen. In this case, the electronic apparatus 100 may output the information about the product to overlap with the broadcast content currently viewed by the user. To indicate that the information about the product related to a specific broadcast content is provided, the electronic apparatus 100 may output a broadcast content name. In addition, the electronic apparatus 100 may output at least one of a brand name, a product name, and a price of the product related to the broadcast content viewed by the user, and a still image of a scene in the broadcast content including the product, as the information about the product, but is not limited thereto.

For example, referring to FIG. 8, when episode 10 of a drama “ABC” is terminated or ends, the electronic apparatus 100 may output information about a product related to the drama “ABC” episode 10, on a partial region 800 of the screen. In this case, to indicate that the information about the product related to the drama “ABC” episode 10 is provided, the electronic apparatus 100 may output a broadcast content name (e.g., Drama “ABC” Episode 10). In addition, the electronic apparatus 100 may output at least one of a brand name (e.g., “xx cosmetic”), a product name (e.g., “AAA Lipstick”), and a price (e.g., [symbol] 15,500) of a lipstick used by a heroine in the drama “ABC” episode 10, and a still image of the heroine who uses the “AAA lipstick” in the drama “ABC” episode 10. For example, when output of the still image of the heroine is not permitted due to a contract related to portrait rights, a copyright, or the like, the electronic apparatus 100 may output an advertisement picture of the “AAA lipstick,” but is not limited thereto.

When a plurality of products are related to the broadcast content viewed by the user, the electronic apparatus 100 may sequentially output information about the products. Alternatively, according to an exemplary embodiment, the electronic apparatus 100 may output information about another product related to the broadcast content in response to an external input for requesting the information about the other product. For example, the external input for requesting the information about the other product may be an input for selecting a left or right directional key of the control device 101, but is not limited thereto. For example, as illustrated in FIG. 8, when the information about the “AAA lipstick” is output and an input for selecting the right directional key of the control device 101 is received, the electronic apparatus 100 may output information about another product related to the drama “ABC” episode 10.

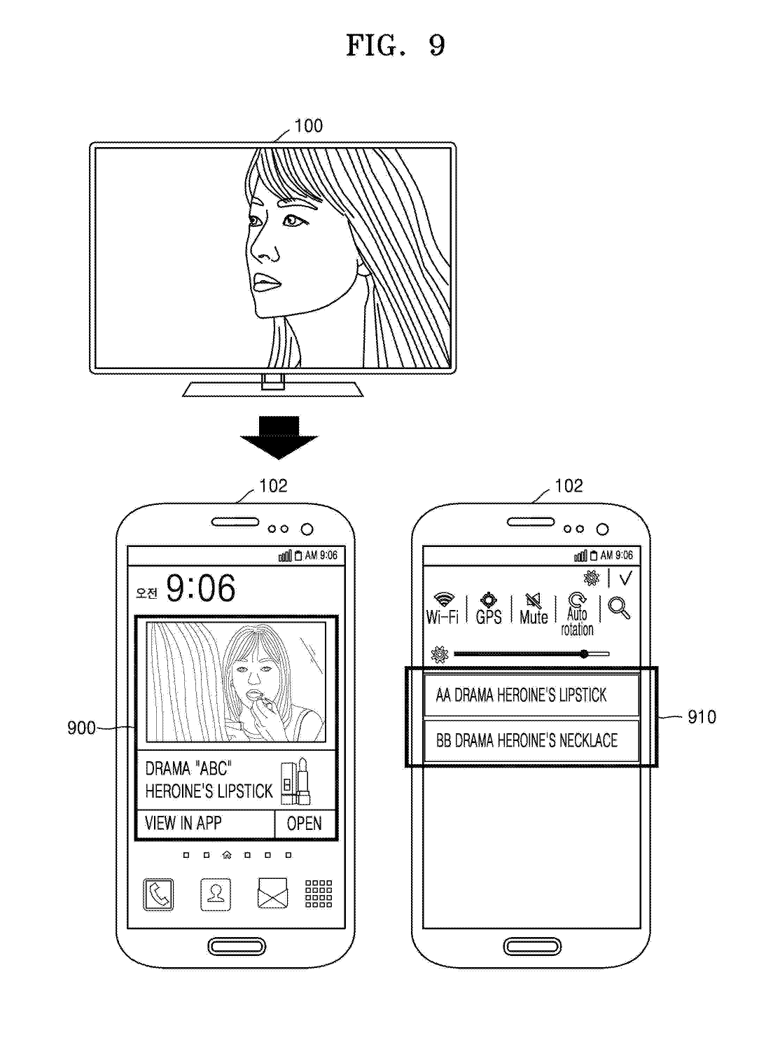

FIG. 9 is a schematic view showing an example in which the electronic apparatus 100 transmits information about a product to an external device 102, according to an exemplary embodiment.

Referring to FIG. 9, the electronic apparatus 100 according to an exemplary embodiment may transmit information about a product related to broadcast content viewed by a user, to the external device 102. For example, when broadcasting of the broadcast content viewed by the user is terminated, the electronic apparatus 100 may transmit the information about the product related to the broadcast content viewed by the user, to the external device 102. Alternatively, according to an exemplary embodiment, the electronic apparatus 100 may transmit the information about the product related to the broadcast content viewed by the user to the external device 102 in real time while the broadcast content is being broadcasted. For example, the information about the product related to the broadcast content may be transmitted in the form of a push message, but is not limited thereto. Referring to FIG. 9, the external device 102 may output the received push message as a popup 900 or on a top bar region 910 of a screen. In addition, the external device 102 may output detailed information about a product indicated by the push message, in response to an input for selecting the received push message. In this case, the external device 102 may provide the detailed information about the product indicated by the push message, by using an application operating in conjunction with the electronic apparatus 100.

Accordingly, the electronic apparatus 100 according to an exemplary embodiment may enable the user to view the broadcast content on the electronic apparatus 100 without being interrupted, by transmitting the information about the product related to the broadcast content viewed by the user to the external device 102.

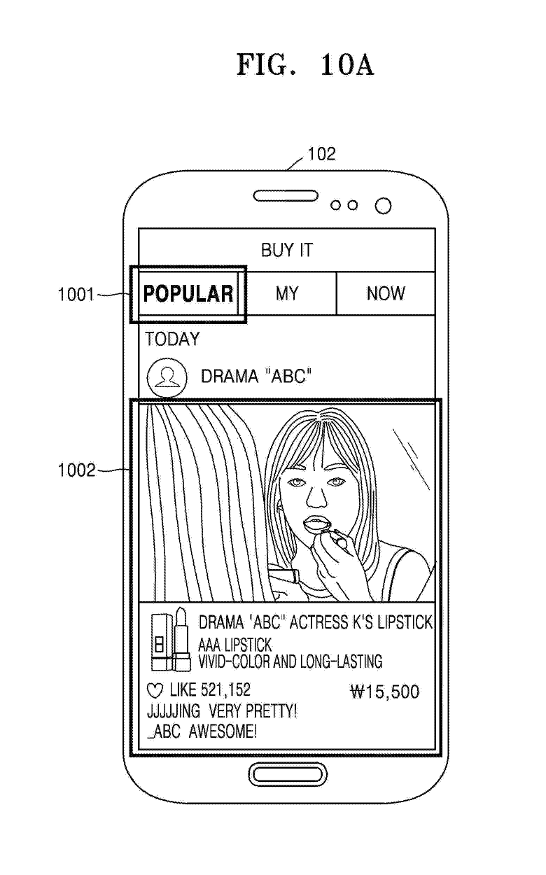

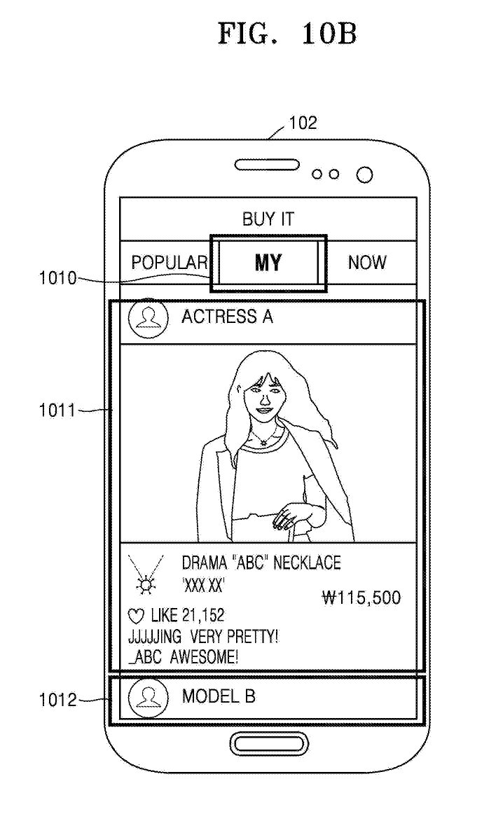

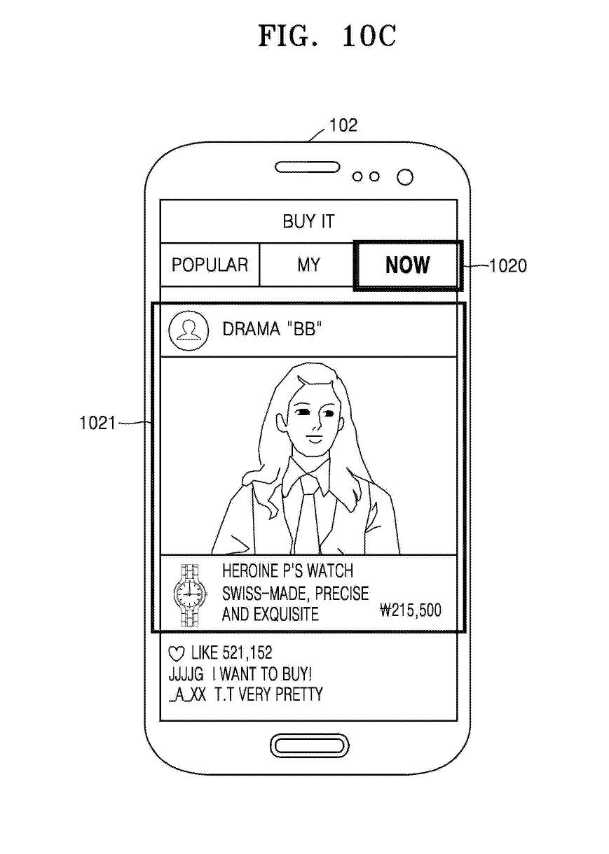

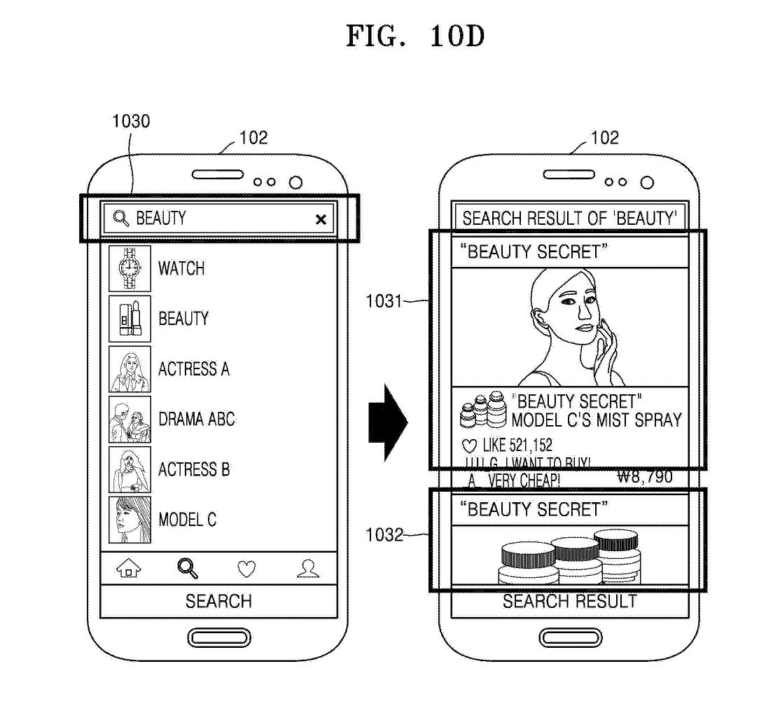

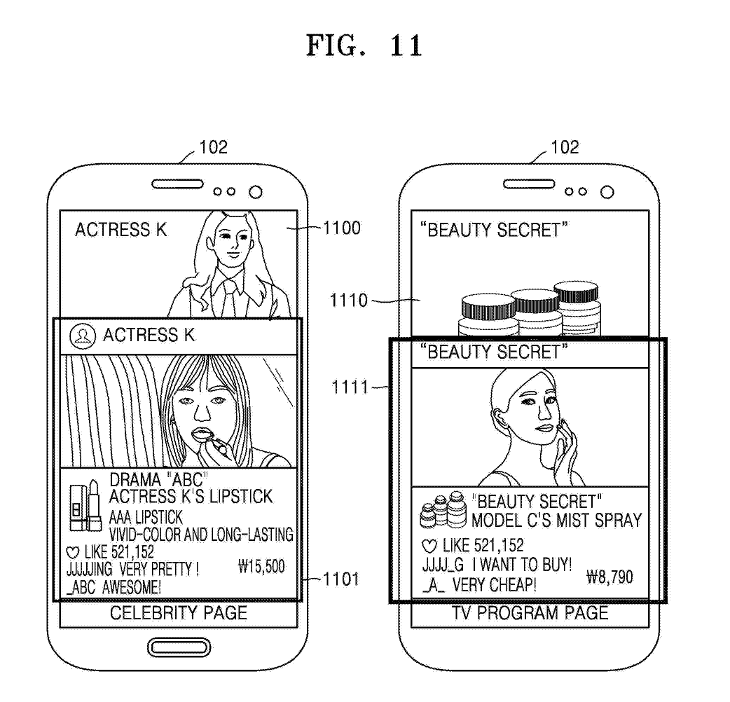

FIGS. 10A to 10D are schematic views showing an example in which the external device 102 provides information about a product related to broadcast content, according to an exemplary embodiment.

According to an exemplary embodiment, when information about products is transmitted from the electronic apparatus 100 to the external device 102, the external device 102 may provide information about a product related to broadcast content viewed by a user, based on the received information. For example, the external device 102 may provide the information about the product related to the broadcast content viewed by the user, by using an application installed in the external device 102. In this case, the product, the information of which is to be provided by using the application, may be determined based on various criteria. For example, the external device 102 may determine the product, the information of which is to be provided, based on a popular product among products related to the broadcast content, a celebrity preferred by the user (e.g., a celebrity or person preselected or designated by a user, or a celebrity or person determined to be preferred by the user according to, for example, the user's viewing history), a product related to a recently-broadcasted broadcast content, or a product related to a currently-broadcasted broadcast content, but is not limited thereto. The external device 102 may distinguishably display information about products determined based on different criteria, on different regions of a screen. For example, the external device 102 may display information about a popular product among the products related to the broadcast content, a celebrity preferred by the user, a product related to a recently-broadcasted broadcast content, and a product related to a currently-broadcasted broadcast content, on different display spaces (e.g., different pages).

For example, referring to FIG. 10A, the external device 102 may display information 1002 about a popular product (e.g., Drama “ABC” Actress K's Lipstick) among the products related to the broadcast content, on a “POPULAR” page 1001. As another example, referring to FIG. 10B, the external device 102 may display information 1011 and 1012 about products related to an actress A and a model B as celebrities preferred by the user, on a “FAVORITE” or “MY” page 1010. For example, the products related to the actress A and the model B may include products used by the actress A and the model B in broadcast contents where the actress A and the model B appear. As another example, referring to FIG. 10C, the external device 102 may display information 1021 about a product related to a drama “BB” which is currently broadcasted in real time, on a “NOW” page 1020.

In addition, the external device 102 according to an exemplary embodiment may set tags for each product related to the broadcast content, as information about the product. The tags may be words or keywords used to search for each product, and may include the name of the broadcast content related to the product and the name of a celebrity who uses the product, but is not limited thereto.

For example, referring to FIG. 10A, “drama “ABC”“ and “actress K” may be set as tags for the drama “ABC” actress K's lipstick. The external device 102 may enable the user to easily find a desired product by using the tags, by setting the tags for each product.

When an external input for moving the location of a focus is received, the external device 102 according to an exemplary embodiment may automatically display an image of a product corresponding to the moved focus. For example, referring to FIG. 10A, when the focus is located on the drama “ABC” actress K's lipstick, the external device 102 may automatically display a video of a scene in the drama “ABC” including the actress K's lipstick.

The external device 102 according to an exemplary embodiment may provide a function of searching products related to broadcast contents. When a specific keyword is input from the user, the external device 102 may display search results based on tags corresponding to each product. For example, referring to FIG. 10D, when a keyword “beauty” 1030 is input from the user, the external device 102 may display products 1031 and 1032, for which words including “beauty” are set as tags, among the products related to the broadcast contents. For example, the external device 102 may provide the products 1031 and 1032, for which “Beauty Secret” including the keyword “beauty” is set as a tag, as the search results. In this case, the products 1031 and 1032, for which “Beauty Secret” is set as a tag, may include products related to a program “Beauty Secret.”

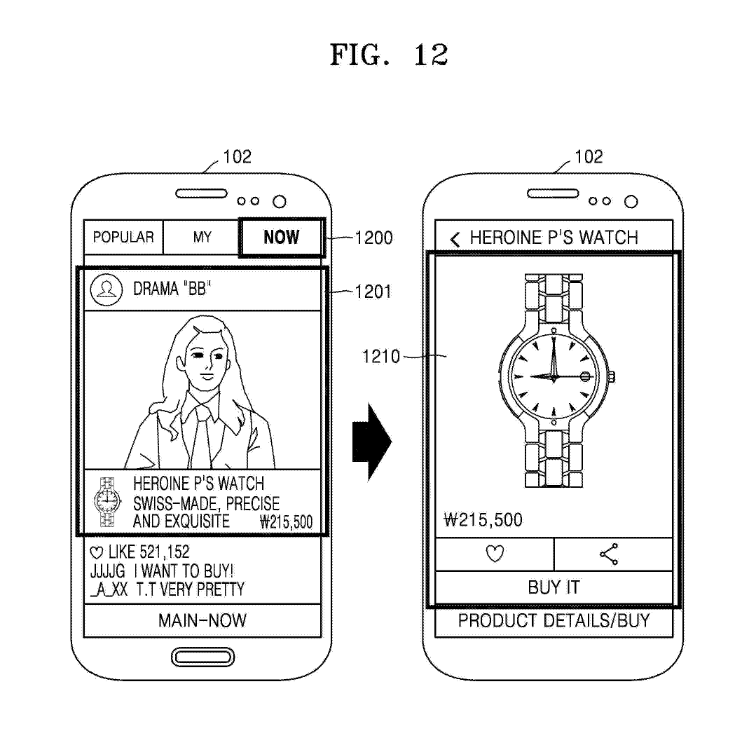

FIG. 11 is a schematic view showing an example in which the external device 102 displays information about products based on tags, according to an exemplary embodiment.

The external device 102 according to an exemplary embodiment may simultaneously display products, for which the same tag is set, among products related to broadcast contents. For example, the external device 102 may provide a display space related to each tag, and display the products, for which the same tag is set, on the display space corresponding to the tag.

For example, referring to FIG. 11, “actress K” may be set as a tag for products used by an actress K in a plurality of broadcast contents. In this case, the external device 102 may display information 1101 about products, for which “actress K” is set as a tag, on a page 1100 related to the actress K. Alternatively, “Beauty Secret” may be set as a tag for products introduced in a program “Beauty Secret.” In this case, the external device 102 may display information 1111 about products, for which “Beauty Secret” is set as a tag, on a page 1110 related to the program “Beauty Secret.” As such, the external device 102 according to an exemplary embodiment may enable the user to conveniently obtain information about products related to a preferred celebrity or products related to a specific program.

FIG. 12 is a schematic view showing an example in which a product is purchased by using a mobile device, according to an exemplary embodiment.

When information 1201 about a product related to broadcast content is displayed, the external device 102 according to an exemplary embodiment may receive an external input for selecting a specific product. When the external input for selecting the specific product is received, the external device 102 may display purchase information of the selected product, and display a menu for moving to an Internet shopping mall or store where the selected product is purchasable. For example, the purchase information of the product may include a price, a brief description, an image, a manufacturer, etc., of the product, but is not limited thereto.

For example, referring to FIG. 12, when an external input for selecting a “Heroine P's Watch” is received, the external device 102 may display purchase information of the “Heroine P's Watch,” and display a menu (e.g., a “Buy it” button 1210) for moving to an Internet shopping mall or store where the “Heroine P's Watch” is purchasable.

As such, the external device 102 according to an exemplary embodiment may enable a user to easily obtain information about a product related to broadcast content and to purchase a desired product.

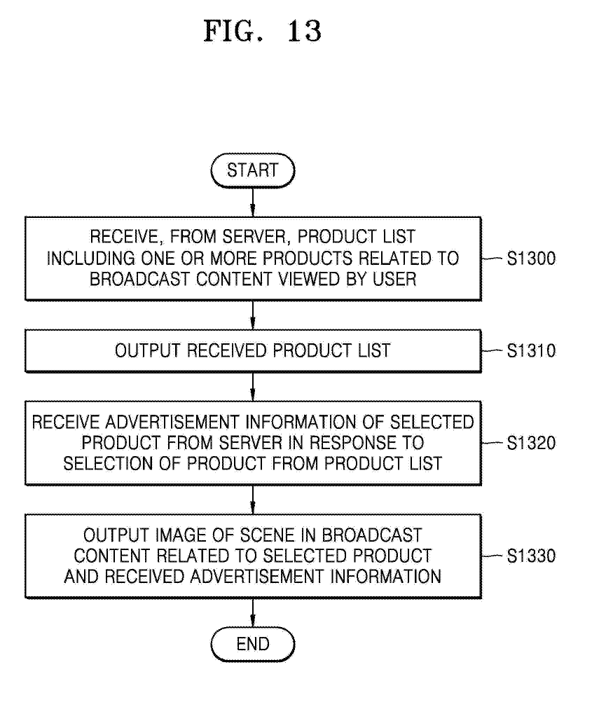

FIG. 13 is a flowchart of a video display method according to an exemplary embodiment.

In operation S1300, the electronic apparatus 100 receives, from an external device (such as a server), a product list including one or more products related to broadcast content viewed by a user. The products related to the broadcast content may include products used in the broadcast content and products introduced in the broadcast content, but are not limited thereto.

In operation S1310, the electronic apparatus 100 outputs the product list received from the server. Herein, the electronic apparatus 100 may display product lists including one or more products related to a plurality of contents viewed by the user, on different regions of a screen. For example, the electronic apparatus 100 may determine a plurality of broadcast contents based on a viewing history of the user. In this case, the plurality of broadcast contents may be determined based on a preference of the user or recently viewed broadcast contents from among the broadcast contents viewed by the user. For example, when first content and second content are determined based on the viewing history of the user, the electronic apparatus 100 may output a first product list including one or more products related to the first content and a second product list including one or more products related to the second content. In this case, the electronic apparatus 100 may output the first and second product lists on different regions of a screen.

The electronic apparatus 100 according to an exemplary embodiment may output the product list by using thumbnail images of scenes in the broadcast content related to the products.

In operation S1320, the electronic apparatus 100 receives advertisement information of a selected product from the external device (e.g., server) in response to a selection of the product from the product list. For example, the advertisement information of the selected product may include at least one of a name, a price, a brand name, a brief description, an image, etc., of the product, but is not limited thereto.

In operation S1330, the electronic apparatus 100 outputs an image of a scene in the broadcast content related to the selected product and the received advertisement information. In this case, the image of the scene in the broadcast content related to the selected product may include a video and a still frame. For example, when a character wears particular shoes in a movie viewed by the user, the electronic apparatus 100 may output a video clip of a scene in the movie including the particular shoes. As such, the electronic apparatus 100 may enable the user to easily check the scene in the broadcast content where the product selected from the product list is shown.

The advertisement information of the selected product may include at least one of a name, a price, a brand name, a brief description, an image, etc., of the product, but is not limited thereto.

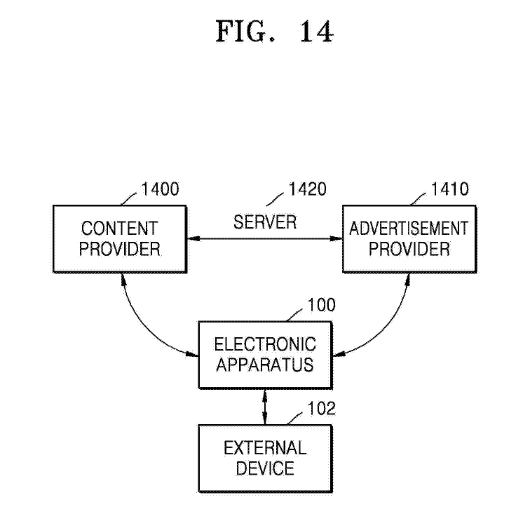

FIG. 14 is a schematic view showing correlations among devices used to implement the video display method, according to an exemplary embodiment.

Referring to FIG. 14, a content provider 1400 according to an exemplary embodiment may be a provider of broadcast content viewed by a user, and may include, for example, a broadcasting company or a video on demand (VOD) service provider, but is not limited thereto.

An advertisement provider 1410 according to an exemplary embodiment may refer to a provider of advertisements for products related to the broadcast content. The advertisement provider 1410 may provide the advertisements to the content provider 1400 or the electronic apparatus 100. According to an exemplary embodiment, the advertisement provider 1410 may provide the advertisements through a server 1420, but is not limited thereto. For example, when the advertisements are received from the advertisement provider 1410, the content provider 1400 may create a final content to be output to the electronic apparatus 100, based on the broadcast content and the advertisements received from the advertisement provider 1410.

The electronic apparatus 100 according to an exemplary embodiment may receive a single content corresponding to a combination of the broadcast content and the advertisements, from the content provider 1400. Alternatively, according to an exemplary embodiment, the electronic apparatus 100 may receive the broadcast content from the content provider 1400 and receive the advertisements from the advertisement provider 1410.

The external device 102 according to an exemplary embodiment may operate in conjunction with the electronic apparatus 100 and provide information about the products related to the broadcast content viewed by the user on the electronic apparatus 100. For example, the external device 102 may output the information about the products related to the broadcast content and enable the user to select and purchase a product, by using an application installed in the external device 102.

The above-described exemplary embodiments can be implemented in the form of program instructions that can be executed through various computer components and recorded on a computer-readable recording medium. The computer-readable recording medium may include program instructions, data files, data structures, or a combination thereof. The program instructions recorded on the computer-readable recording medium may be program instructions specially designed and configured for the present disclosure or program instructions known to and usable by one of ordinary skill in the art of computer software. Examples of the computer-readable recording medium include magnetic media (e.g., a hard disk, a floppy disk, and a magnetic tape), optical media (e.g., a CD-ROM and a DVD), magneto-optical media (e.g., a floptical disk), and hardware devices specially configured to store and execute program instructions (e.g., a ROM, a RAM, and a flash memory). Examples of the program instructions include machine code generated by a compiler and high-level language code that can be executed by a computer using an interpreter or the like.

It should be understood that exemplary embodiments described herein should be considered in a descriptive sense only and not for purposes of limitation. For example, a single element in the above description may be divided into a plurality of elements, and a plurality of elements in the above description may be combined into a single element. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. An electronic apparatus for providing information about products, the electronic apparatus comprising:
a communication interface; and
at least one processor configured to:
control the communication interface to receive, from one or more servers, a product list comprising one or more products related to broadcast content viewed by a user;
control to output the received product list;
control the communication interface to receive, from the one or more servers in response to a selection of a product from the output product list, advertisement information of the selected product; and
control to output the received advertisement information and an image of a scene in the broadcast content related to the selected product.

2. The electronic apparatus of claim 1, further comprising a display,
wherein the at least one processor is further configured to control the display to display the received product list, the image of the scene in the broadcast content related to the selected product, and the received advertisement information related to the selected product.

3. The electronic apparatus of claim 1, wherein the at least one processor is further configured to control to output, based on outputting of the broadcast content ending, a notification message for providing information about the one or more products related to the broadcast content, and to control to output the received product list comprising the one or more products related to the broadcast content, outputting of which is ended, in response to receiving an input for selecting the notification message.

4. The electronic apparatus of claim 1, wherein the at least one processor is further configured to determine first content and second content based on a viewing history of the user, and to control to output a first product list comprising one or more products related to the first content and a second product list comprising one or more products related to the second content.

5. The electronic apparatus of claim 4, wherein the at least one processor is further configured to determine the first content and the second content based on at least one of a preference of the user and broadcast contents recently viewed by the user.

6. The electronic apparatus of claim 1, wherein the received advertisement information of the selected product comprises at least one of a name, a price, a manufacturer, a brief description, and an image of the product.

7. The electronic apparatus of claim 1, wherein the at least one processor is further configured to control to output the received product list by using thumbnail images of scenes in the broadcast content related to the one or more products.

8. The electronic apparatus of claim 1, wherein the at least one processor is further configured to control to transmit a message comprising purchase service information for purchasing the selected product to an external device in response to receiving an external input for selecting the product from the output product list.

9. The electronic apparatus of claim 1, wherein:
the product list comprises a first product and a second product; and
the at least one processor is further configured to control to output advertisement information of the first product and an image of a scene in the broadcast content related to the first product, and to control to output advertisement information of the second product and an image of a scene in the broadcast content related to the second product based on outputting of the advertisement information of the first product ending.

10. The electronic apparatus of claim 1, wherein the at least one processor is further configured to control to output a broadcast content list comprising one or more broadcast contents based on a viewing history of the user and to control to output a product list comprising one or more products related to a selected broadcast content in response to receiving an input for selecting the broadcast content from the output broadcast content list.

11. The electronic apparatus of claim 1, wherein the at least one processor is further configured to transmit, to an external device, a notification message for providing information about the one or more products related to the broadcast content.

12. A method of operating an electronic apparatus, the method comprising:
receiving, from one or more servers, a product list comprising one or more products related to broadcast content viewed by a user;
outputting the received product list;
receiving, from the one or more servers, advertisement information of a selected product in response to a selection of the product from the output product list; and
outputting the received advertisement information and an image of a scene in the broadcast content related to the selected product.

13. The method of claim 12, further comprising:
outputting, based on outputting of the broadcast content ending, a notification message for providing information about the one or more products related to the broadcast content,
wherein the outputting of the received product list comprises outputting the received product list comprising the one or more products related to the broadcast content, outputting of which is ended, in response to receiving an input for selecting the notification message.

14. The method of claim 12, further comprising:
determining first content and second content based on a viewing history of the user; and
outputting a first product list comprising one or more products shown in the first content and a second product list comprising one or more products shown in the second content.

15. The method of claim 14, wherein the determining of the first content and the second content comprises determining the first content and the second content based on at least one of a preference of the user and information about broadcast contents recently viewed by the user.

16. The method of claim 12, wherein the received advertisement information of the selected product comprises at least one of a name, a price, a manufacturer, a brief description, and an image of the product.

17. The method of claim 12, wherein the outputting of the received product list comprises outputting the received product list by using thumbnail images of scenes in the broadcast content related to the one or more products.

18. The method of claim 12, further comprising:
transmitting a message comprising purchase service information for purchasing the selected product to an external device in response to receiving an external input for selecting the product from the output product list.

19. The method of claim 12, wherein:
the product list comprises a first product and a second product; and
the method further comprises:
outputting advertisement information of the first product and an image of a scene in the broadcast content related to the first product; and
outputting advertisement information of the second product and an image of a scene in the broadcast content related to the second product based on outputting of the advertisement information of the first product ending.

20. A non-transitory computer-readable recording medium having recorded thereon a program for executing the method of claim 12.
